(19) United States
(12) Patent Application Publication
(10) Pub. No.: US 2005/0111753 A1
(43) Pub. Date: May 26, 2005

(54) Image mosaicing responsive to camera ego motion

(75) Inventors: Shmuel Peleg, Mevaseret-Zion (IL); Alexander Rav-Acha, Jerusalem (IL); Yael Shor, Tel-Aviv (IL)

Correspondence Address: William H. Dippert, Esq.;c/o Reed Smith LLP, 29th Floor, 599 Lexington Avenue, New York, NY, 10022-7650, US

(73) Assignees: Yissum Research Development Company of the Hebrew University of Jerusalem, Jerusalem (IL); HumanEyes Technologies Ltd., Jerusalem (IL)

(21) Appl. No.: 10/835,596

(22) Filed: Apr. 29, 2004

Related U.S. Application Data
(60) Provisional application No. 60/524,675, filed on Nov. 20, 2003.
(60) Provisional application No. 60/552,393, filed on Mar. 9, 2004.

(51) Int. Cl. G06K 9/36; G06K 9/00

(52) U.S. Cl. 382/284; 382/154

(57) ABSTRACT

A method of generating a mosaic from a plurality of camera images of a scene acquired by a camera moving relative to the scene, the method comprising: associating with each camera image a value of at least one variable so that the variable is a substantially a linear function of a spatial coordinate that defines the locations of the camera at which it acquires the images by requiring that a coordinate of pixels in the camera images that image a same feature in the scene is substantially a linear function of the variable; and generating the mosaic responsive to the at least one variable.

### RELATED APPLICATIONS

The present application claims benefit under 35 U.S.C. 119(e) of U.S. Provisional Application 60/524,675 filed Nov. 20, 2003 and U.S. Provisional Application 60/552,393 filed Mar. 9, 2004, the disclosures of which are incorporated herein by reference.

### FIELD OF THE INVENTION

The invention relates to methods of producing a mosaic of a scene from a sequence of video images of the scene acquired by a moving camera and in particular by a camera undergoing translational motion.

### BACKGROUND OF THE INVENTION

It is often desirable to generate an image of a scene that provides more visual information than is readily acquired from a single camera image of the scene. For example, it is common practice to match and “splice” together image data from a sequence of images acquired by an airborne camera or a satellite mounted camera to provide a composite image of the scene that comprises more visual information than any single one of the images. In more mundane applications it is often desired to match and splice together portions of images acquired by panning a scene with a video or still camera to provide an image of the scene that includes more of the scene than is captured in the field of view of the camera. Splicing together portions of different images of a scene to provide a composite image is conventionally referred to as “mosaicing” and the resultant composite image a “panorama” or a “mosaic”.

Whereas it might appear to be relatively straightforward to match and splice portions of photographs of a scene to generate a mosaic or panorama of the scene, it turns out that it is often a relatively complicated task to generate a mosaic that is not compromised by substantial motion distortions. Motion distortions in a mosaic are distortions that result from improperly accounting for motion of the camera relative to features in the scene in generating the mosaic.

For situations in which motion, conventionally referred to as “ego motion”, of a camera used to acquire images of a scene and times at which the images are acquired are known, it is generally possible to process the images to provide a mosaic of the scene that is relatively free of motion distortion. However, it is often the case that camera ego motion is not known, and even if presumably known, undergoes unforeseen and undetected changes, for example changes in velocity as a result of malfunction or disturbance of apparatus that transports the camera. While there are methods for determining camera ego motion relative to a scene from images that the camera acquires of the scene, these methods are usually relatively time consuming tend to be mathematically unstable, and in general are not used for mosaicing.

Data comprised in a sequence of images of a scene acquired by a camera is often represented as a function of coordinates in a space time (ST) volume. An ST volume is a rectangular volume defined by arraying the images parallel to each other and aligned one behind the other in the order in which they were acquired. A location of a given pixel in the images used to generate the ST volume is determined by a time coordinate and two spatial “image” coordinates. The time coordinate is measured along a t-axis perpendicular to the planes of the camera images. The two spatial image coordinates are measured along spatial axes parallel to the planes of the camera images, which are conventionally x and y orthogonal image axes. The x and y image coordinates of a pixel in a camera image acquired at a given time t (as measured for example along the t-axis) correspond to “real world” x and y-coordinates of a feature in the scene imaged on the pixel. Hereinafter, to distinguish camera image coordinates from real world coordinates, camera image coordinates are primed.

Typically, cameras used to acquire a sequence of images for generating a mosaic of a scene are programmed to acquire the images at regular time intervals. The spacing between adjacent images in an ST volume defined by the images is therefore usually uniform. In some methods, distances to features in the scene are determined from sources other than the images themselves using accessories, such as laser range finders, or extraneous information such as GPS data or a-priori knowledge. In such instances spacing between adjacent images may be adjusted responsive to the distance measurements. An ST volume is generally particularly useful for situations in which the camera moves substantially along a straight line and acquires images at known “imaging times”.

It is usual to define the image x′-axis and y′-axis as axes that correspond respectively to the real world x and y axes so that for a displacement of the camera along the world x-axis or y-axis, a feature in a camera image displaces along the negative image x′-axis or negative image y′-axis respectively. Conventionally, for translational motion of a camera along a substantially straight line, the world x-axis is assumed to substantially coincide with the line along which the camera moves and the world y-axis is perpendicular to the camera motion. For example, for a camera mounted on a ground vehicle moving relative to a scene, the world x-axis is a horizontal axis parallel to the ground and the world y-axis a vertical axis perpendicular to the ground.

A plane through the ST volume parallel to the y′t plane is referred to as a “mosaic plane”. For an ideal ST volume of the scene, the camera images in the ST volume are “infinitely” dense along the time axis and an image of a mosaic plane provides a mosaic image of the scene. In practice, the time axis of an ST volume is relatively sparsely populated with camera images and an image of a mosaic plane of the ST volume does not in general provide a continuous mosaic of the scene. Instead, the image comprises a plurality of discrete parallel lines, hereinafter referred to as “mosaic lines”, of pixels, each of which coincides with an intersection line of the mosaic plane with a different one of the camera images comprised in the ST volume.

Various methods are known in prior art for filling in spaces between the mosaic lines in a mosaic plane of an ST volume of a scene and providing a continuous mosaic of the scene from data in the mosaic plane. Many mosaic algorithms, conventionally referred to as “2D methods”, which are used to generate a mosaic of a scene from a sequence of images acquired by a moving camera, process consecutively acquired images to determine 2D spatial transformations between the images. The transformations are used to spatially register the images one to the other. Registered images are then combined into a mosaic image using any of various mosaicing techniques such as those described in U.S. Pat. No. 6,665,003, U.S. Pat. No. 6,532,036, U.S. Pat. No. 6,075,905, U.S. Pat. No. 5,649,032, U.S. Pat. No. 6,393,163 and U.S. Pat. No. 6,097,854, the disclosures of which are incorporated herein by reference.

In some techniques, in order to provide a continuous mosaic, a strip is determined, hereinafter referred to as “mosaic strip”, for each camera image, which includes the mosaic line that lies at the intersection of the camera image and the mosaic plane. Typically, the width of each mosaic strip is determined responsive to the spacing between mosaic lines determined by the 2D algorithm. The strips from consecutive camera images are juxtaposed contiguously to form the mosaic.

In some methods the spaces between the mosaic lines are filled with “intermediate” pixels having values interpolated from pixel values of pixels in the mosaic lines. In some methods values for pixels between intermediate pixels are determined from averages of pixels in the images that image same features in the scene that are located between features imaged by pixels in the mosaic lines.

2D methods are generally practical for determining spacing between mosaic lines that are proportional to actual displacements of the camera between times at which the camera images a scene for relatively flat scenes for which depth changes relative to the camera are relatively small. A flat scene, for example, may be a scene for which substantially all features in the scene are relatively far from the camera. For scenes that are characterized by substantial changes in depth relative to the camera, 2D methods often provide spacings between mosaic lines that are not proportional to camera displacements, and as a result generate mosaics that often exhibit substantial motion distortions.

An epipolar (EP) plane of an ST volume is a plane that is parallel to the x′t plane of the ST volume and passes through the ST volume at a given image y′-coordinate. In some methods of generating a mosaic from a sequence of camera images, data comprised in an EP plane of an ST volume is used together with known depth data to determine ego motion of the camera for use in providing the mosaic.

Data comprised in EP planes is commonly used to determine relative distances of features in the sequence of camera images from the camera that acquires the images. A feature in the scene that is located at fixed world y and z-coordinates, relative to the camera ego motion is imaged on pixels in the camera images that have a same image y′-coordinate. Note, this is of course true for a feature moving parallel to the world x-axis and in general for a feature moving in a plane through the optic center of the camera that intersects the camera's focal plane along the line parallel to the x′ axis at the y′-coordinate. In an image of an EP plane at the y′-coordinate of the pixels, the pixels define a trajectory, hereinafter referred to as an “EP trajectory”. The slope of the EP trajectory at a given time is a rate of change of the x′-coordinate of the pixel in the camera images as a function of time and is therefore a speed, hereinafter referred to as a “pixel speed”. For a fixed feature in the scene and for camera motion for which the z-coordinate of the camera does not change, the pixel speed of the feature is proportional to the magnitude of the velocity of camera motion and inversely proportional to the distance of the feature from the camera. For such cases pixel speed is often used to indicate the distance of the feature from the camera relative to distances of other features in the scene. In general, the EP trajectory of a feature is curvilinear and may be segmented.

R. C. Bolles, et al., discuss generating depth information for features in a scene from EP planes for a camera moving at constant velocity in an article entitled “Epipolar-plane image analysis: An approach to determining structure from motion?” Intern. J. Computer Vision 1:7-55, 1987, the disclosure of which is incorporated herein by reference. Bolles et al. do not use the depth information for mosaicing.

Zhigang Zhu, et al., in an article entitled, “Panoramic EPI Generation and Analysis of Video from a Moving Platform with Vibration”, Proceedings of the IEEE Conference on Computer Vision and Pattern Recognition, 23-25 Jun., 1999, Fort Collins, Colorado, vol 2, pp. 531-537, the disclosure of which is incorporated herein by reference, describes using data comprised in EP planes to reduce deleterious effects of camera vibration on quality of a mosaic generated from camera images of a scene acquired by the camera. The camera is assumed to be moving relative to the scene with a constant translational velocity that is perturbed by vibrations. The effects of vibrations are treated as perturbations of EP trajectories of sets of points in the images that image a same point in the scene and cause the EP trajectories to deviate from smooth or piecewise straight curves. Smooth or piecewise straight curves are fit to sets of points that image a same feature to estimate the perturbations resulting from the vibrations and to moderate their effects on the mosaic.

An article by S. Ono et al., “Ego-Motion Estimation for Efficient City Modeling by Using Epipolar Plane Range Image Analysis”, Proc. 10th World Congress on Intelligent Transport Systems and Services (ITSWC2003), November 2003, the disclosure of which is incorporated herein by reference, describes using a laser range finder and pixel velocity to determine camera ego motion and generate a mosaic.

### SUMMARY OF THE INVENTION

An aspect of some embodiments of the invention relates to providing a method of generating a mosaic image of a scene that is relatively free of motion distortions from a sequence of camera images of the scene acquired by a camera being translated relative to the scene.

An aspect of some embodiments of the present invention relates to using data comprised in an epipolar (EP) plane of an ST volume defined by the sequence of images to provide the mosaic.

In some embodiments of the invention, the camera is assumed to move along a straight line. In some embodiments of the invention, the camera is assumed to move along an arc of a circle.

In accordance with an embodiment of the invention, the temporal intervals between camera images in the sequence of camera images in the ST volume are adjusted, or time “warped”, so that EP trajectories in at least one EP plane of the camera images, which as noted above may be curvilinear, are morphed into straight lines. As a result, each camera image is “assigned” an adjusted or warped time. The warped times are such that the warped temporal interval between any two camera images in the sequence of images is proportional to the actual spatial displacement of the camera relative to the scene between the actual times at which the two images are acquired.

A mosaic of the scene is generated responsive to data comprised in a mosaic plane in the ST volume generated from the time warped sequence of camera images, i.e. from data in the mosaic plane and the warped time intervals between camera images in the ST volume. Since the warped time intervals are proportional to the displacements of the camera between the actual positions, hereinafter “imaging positions”, at times at which the camera acquires images of the scene, the mosaic is relatively free of motion distortions that are often typical of prior art mosaics.

In some embodiments of the invention the mosaic is generated by generating values for “intermediate” pixels at locations between mosaic lines in a mosaic plane of the ST volume responsive to the warped time intervals and values of the pixel using any of various methods known in the art.

In some embodiments of the invention, the mosaic is generated from mosaic strips from the camera images, each of which strips includes pixels from a mosaic pixel line of a camera image comprised in the mosaic plane. Optionally, the width of a mosaic strip from a camera image is determined responsive to the time warped time intervals between successive camera images in the ST volume. Optionally, the width of a mosaic strip from a camera image is determined both from the time warped intervals and an estimated distance from the camera of features in the scene imaged in the strip.

In some embodiments of the invention the camera is assumed to move in a plane. For motion of a camera moving along a straight line or along an arc of a circle, a single coordinate (e.g. the coordinate x for motion along a line and or an angular coordinate for motion in an arc) defines imaging positions of the camera along its path of motion at which it acquires images of a scene. Morphing EP trajectories into straight lines establishes a linear relationship between the x′-coordinates of pixels that image a feature in the scene and the warped times assigned the acquired camera images. As a result, the warped times are a linear function of the single coordinate and the warped time intervals between times assigned the camera images are proportional to the displacements of the camera between the imaging positions at which the images are acquired.

The invention however is not limited to one-dimensional motion of the camera in which a single coordinate determines camera imaging positions along its path of motion. The invention may be practiced for two-dimensional camera motion, for example planar motion or motion on the surface of a sphere, in which two coordinates are required to determine imaging positions of the camera.

For example, for two-dimensional motion in a plane or on the surface of a sphere, in accordance with an embodiment of the invention, each camera image is associated with two parameters such that each of the coordinates x′ and y′ of pixels in the camera images that image a feature in the scene are linear functions of at least one of the parameters. The values of the two parameters are therefore linear functions of the spatial coordinates that define the camera imaging positions in the plane and changes in the parameters are proportional to changes in the position of the camera. In accordance with an embodiment of the invention, a mosaic of the scene is generated responsive to the values of the two parameters.

There is therefore provided in accordance with an embodiment of the present invention, a method of generating a mosaic from a plurality of camera images of a scene acquired by a camera moving relative to the scene, the method comprising: using data comprised in the camera images to associate with each camera image a value of at least one variable so that the variable is a linear function of a spatial coordinate that defines the locations of the camera at which it acquires the images; and generating the mosaic responsive to the at least one variable.

In some embodiments of the invention, the at least one variable is a single variable. In some embodiments of the invention, the camera moves along a straight line and the spatial coordinate determines displacement of the camera along the line. In some embodiments of the invention, the camera moves along an arc of a circle and the spatial coordinate is an angle that determines location of the camera among the arc. In some embodiments of the invention, the camera moves in a plane and the spatial coordinate is a coordinate that determines the location of the camera along an axis in the plane. In some embodiments of the invention, the camera moves on the surface of a sphere and the spatial coordinate is an angle that determines the location of the camera on the surface relative to a direction of an axis through the center of the sphere.

In some embodiments of the invention, associating with each camera image a variable comprises associating a value of the variable with the camera image by requiring that a coordinate of pixels in the camera images that image a same feature in the scene is substantially a linear function of the variable.

In some embodiments of the invention, the variable is a time coordinate along a time axis of a space-time (ST) volume defined by the images. Optionally, associating values of the time coordinate comprises associating the values by requiring that at least one trajectory in an epipolar (EP) plane of the ST volume defined by pixels that image a same feature in the scene is substantially a straight line.

In some embodiments of the invention, associating the values of the time coordinate comprises determining the values so that they optimize at least one global measure responsive to coordinates of the pixels in the EP plane that has a value indicative of an extent to which EP trajectories in the EP planes are straight lines. Optionally, the global measure comprises the entropy of at least one transform. Optionally, the at least one transform comprises a Fourier transform. Additionally or alternatively, the at least one transform comprises a Radon transform.

In some embodiments of the invention, associating the values of the time coordinate comprises determining the values using an iterative procedure. Optionally, using an iterative procedure comprises associating a time coordinate value for each camera image in turn responsive to time coordinate values already determined for other camera images.

In some embodiments of the invention, associating the values of the time coordinate comprises visually spacing the camera images along the time axis so that the at least one trajectory is substantially a straight line.

In some embodiments of the invention, generating the mosaic comprises generating an image of a mosaic plane of the ST volume, which image of the mosaic plane comprises pixels in the camera images that lie along mosaic lines, which are lines of intersection of the mosaic plane with the camera images.

Optionally, generating the mosaic comprises generating values for pixels in the mosaic plane at locations between mosaic lines responsive to the associated time coordinates.

Optionally, generating the mosaic comprises defining a mosaic strip for each camera image in the ST volume that comprises the mosaic line in the camera image and juxtaposing the mosaic strips contiguous with each other to generate the mosaic. Optionally, the method comprises determining a width for the mosaic strip of a given camera image in the ST proportional to differences between the time coordinate assigned the given camera image and the time coordinates assigned adjacent camera images in the ST volume. Optionally, the method comprises determining the width of the strip responsive to a distance of a feature in the scene that is imaged in the strip.

In some embodiments of the invention, two spatial coordinates define the camera position and the at least one variable comprises two variables. Optionally, each variable is a linear function of a different spatial coordinate. In some embodiments of the invention, the camera moves in a plane and the different coordinates comprise two coordinates that define the location of the camera in the plane. In some embodiments of the invention, the camera moves on a region of a spherical surface and the different spatial coordinates comprise two angles that define the location of the camera on the region.

In some embodiments of the invention, associating with each camera image values of the two variables comprises associating the values so that each of two coordinates of pixels in the camera images that image a same feature in the scene is a linear function of at least one of the variables. Optionally, each pixel coordinate is a linear function of a different one of the variables.

In some embodiments of the invention, the optic axis of the camera is substantially perpendicular to the locus of its motion or the camera images are rectified to correspond to camera images acquired with the camera optic axis perpendicular to its locus of motion.

In some embodiments of the invention, the mosaic corresponds to an image of the scene oriented at a 0° azimuth angle relative to the optic axis of the camera. Alternatively, the mosaic corresponds to an image of the scene oriented at an azimuth angle other than 0° relative to the optic axis of the camera. Optionally, the mosaic comprises pixels that image features in the scene at different azimuth angles relative to the optic axis of the camera.

### BRIEF DESCRIPTION OF FIGURES

Non-limiting examples of embodiments of the present invention are described below with reference to figures attached hereto, which are listed following this paragraph. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A and 1B are perspective and plan views respectively of a camera translating at constant velocity relative to a scene while acquiring a sequence of images of the scene and illustrate generating a mosaic of the scene from the images in accordance with an explanatory example;

FIGS. 2A and 2B are perspective and plan views respectively of a camera translating relative to the scene shown in FIGS. 1A and 1B while acquiring a sequence of images of the scene wherein the velocity of translation changes and generates motion distortion in a mosaic generated from the image sequence in accordance with prior art assuming constant ego-motion;

FIGS. 3A and 3B are perspective and plan views respectively of a camera translating relative to the scene shown in FIGS. 1A and 1B while acquiring a sequence of images of the scene wherein the velocity of translation changes and generates motion distortion in a mosaic generated from the image sequence in accordance with prior art assuming constant ego-motion;

FIGS. 4A and 4B are perspective and plan views respectively of a translating camera acquiring a sequence of images of a scene having substantial depth variation and illustrates motion distortion resulting from the depth variation in a mosaic generated from the image sequence using a 2D method in accordance with prior art;

FIGS. 5A and 5B are perspective and plan views respectively that illustrate generating a mosaic having relatively reduced motion distortion of the scene shown in FIGS. 2A and 2B, in accordance with a prior art 2D method and an embodiment of the present invention; and

FIGS. 6A and 6B are perspective and plan views respectively that illustrate generating a mosaic having relatively reduced motion distortion of the scene shown in FIGS. 4A and 4B, in accordance with an embodiment of the present invention;

FIGS. 7A and 7B are perspective and plan views respectively of a camera moving in a circle and acquiring a sequence of images of a scene and illustrate determining an angular position of the camera for use in generating a mosaic in accordance with an embodiment of the invention; and

FIGS. 8A and 8B are perspective and plan views respectively of a camera moving in a plane and acquiring a sequence of images of a scene and illustrate determining positions of the camera in the plane for use in generating a mosaic in accordance with an embodiment of the invention.

### DETAILED DESCRIPTION OF EMBODIMENTS OF THE INVENTION

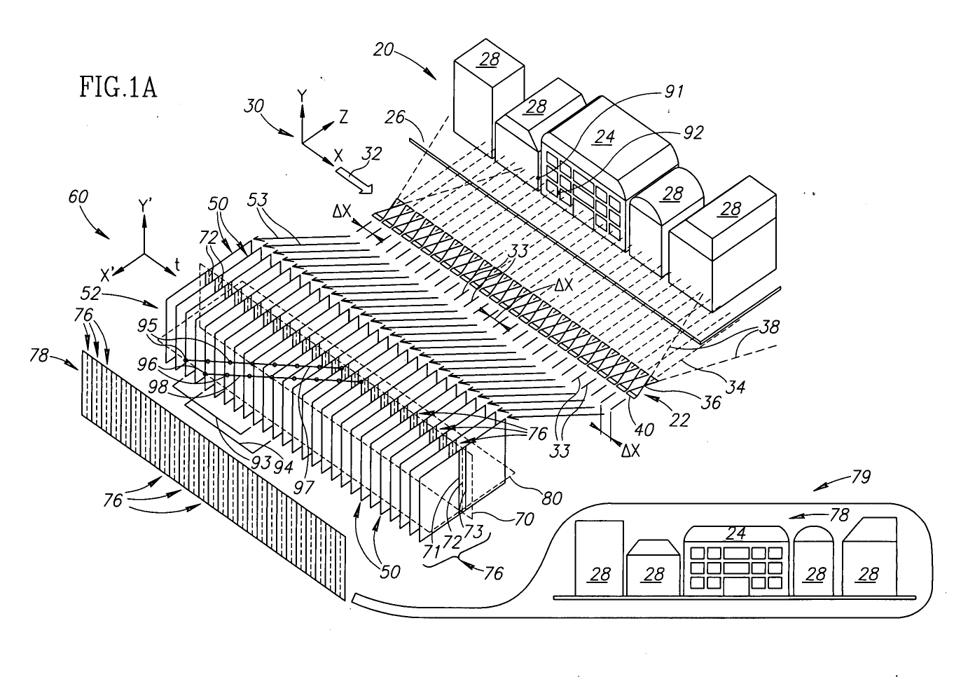

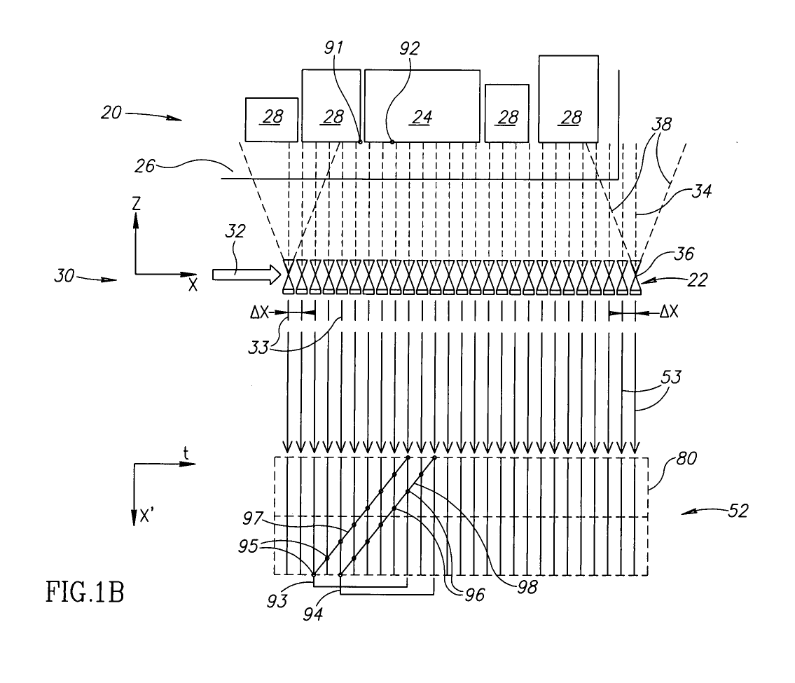

FIGS. 1A and 1B schematically illustrate generating a mosaic of a street scene 20 from a sequence of video images acquired of the scene by a camera represented by an hourglass shaped icon 22 moving relative to the street scene, in accordance with prior art. FIG. 1A shows a schematic perspective view of street scene 20 and camera 22 and FIG. 1B shows a plan view of the street scene and camera.

For convenience of presentation, a “real world” coordinate system 30 is used to reference locations of features of scene 20 and motion of camera 22 relative to the scene. World coordinate system 30 comprises a horizontal x-axis substantially parallel to street 26 and a vertical y-axis substantially perpendicular to the street. Objects in street scene 20 have a height above ground level measured along the y-axis and depth of features in scene 20 is measured along the z-axis of coordinate system 30.

Street scene 20 comprises a central building 24 on a street 26 and buildings 28 that flank the central building. By way of example, and to simplify the discussion, the fronts of all buildings 24 and 28 are located at substantially a same z-coordinate “Zₒ”. Scene 20 is therefore a “flat scene” relative to the positions of camera 22 along its path of motion.

The ego motion of camera 22 is assumed to be known and, by way of example, the camera is assumed to be moving with constant velocity along a straight horizontal line substantially coincident with the x-axis in a direction indicated by a block arrow 32. The camera is assumed to be acquiring images of scene 20 at regular intervals every Δt seconds. Since camera 22 is also assumed to be moving at constant velocity, the camera acquires the images at positions, i.e. imaging positions, schematically indicated by witness lines 33, which are equally spaced one from the other along the x-axis by a distance Δx=V_{C}Δt where V_{C} is the speed with which the camera moves along the x-axis.

Camera 22 comprises an optical system (not shown) having an optic axis 34 and an optic center 36 located at the intersection point of the sides of the hourglass icon representing the camera. The optical system has a field of view having an extent schematically indicated by extreme light rays 38 (shown, to prevent clutter, for only outermost imaging positions 33 of camera 22) and focuses light from scene 20 to a photosensitive surface 40.

The number of imaging positions 33 shown in FIG. 1A and figures that follow at which camera 22 acquires images of scene 20 and spacing between the positions are chosen for convenience of presentation. A number of imaging positions at which a camera images a scene to provide a sequence of camera images from which to provide a mosaic of the scene, and consequently the number of camera images in the sequence, are often much greater than that schematically indicated in the figures. Spacing between imaging positions 33 of camera 22 at which the images are acquired is also often much less than schematically indicated in the figures. However, it is noted that a mosaic may be generated from camera images acquired at imaging positions that are spaced apart by distances that are greater than those schematically indicated by imaging positions 33.

In the discussion below it is assumed for simplicity that spacing between imaging positions of camera 22 is substantially less than a distance parallel to the motion of the camera over which features in a scene imaged by the camera undergo substantial change. As in FIGS. 1A and 1B, spacing between imaging positions in other figures is shown exaggerated for convenience of presentation.

A camera image 50 is schematically shown for each imaging position 33 and the camera images are arrayed to provide an ST volume 52 of scene 20. An arrow 53 from a given camera imaging position 33 to a camera image 50 in ST volume 52 indicates which camera image 50 is associated with the given imaging position. Since camera images 50 are acquired at regular time intervals Δt, the camera images are spaced one from the other in ST volume 52 by a same distance proportional to Δt.

A given pixel is located in ST volume 52 by an x′-coordinate, a y′-coordinate and a t-coordinate in a “camera image” coordinate system 60. The t-coordinate locates a particular camera image of scene 20 in ST volume 52 in which the given pixel is located and the x′ and y′-coordinates locate the position of the pixel in the particular camera image. The x′ and y′-axes are optionally parallel respectively to the x and y-axes of coordinate system 30 in the sense that a displacement of a feature in scene 20 along the world x-axis or y-axis is translated into a displacement along the image x′-axis or y′-axis respectively in a camera image 50 in which the feature is imaged.

A dashed rectangle 70 outlined in dashed lines represents a mosaic plane parallel to the y′t-plane of image coordinate system 60 that passes through camera images 50 comprised in ST volume 52. By way of example, mosaic plane 70 intersects each camera image 50 along a line 72 hereinafter a “mosaic line 72”, which optionally passes through a pixel on which the center of the field of view of camera 22 is imaged. A dashed rectangle 80 represents an EP plane of ST volume 52 parallel to the x′t-plane of image coordinate system 60 that passes through camera images 50.

Because camera 22 is assumed to have a constant y-coordinate as it moves relative to scene 20, the y′-coordinates of coordinate system 60 have a relatively simple relation to the y-coordinates of features in scene 20. A feature in scene 20 having a given y-coordinate is imaged on pixels having a same y′-coordinate in all camera images 50 of scene 20 acquired by camera 22 in which the feature is imaged. Features in scene 20 that have a same world y-coordinate are imaged on pixels that have a same image y′-coordinate in all images 50 in which the features are imaged.

However, the x′-coordinate of a pixel that images a feature is a function of the camera image 50 in which the feature is imaged because the camera is moving in the x-direction. For example, assume a feature in the field of view of camera 22 is imaged on a pixel having an x′-coordinate equal to x′(t₁) in an image acquired at a time t=t₁ when camera 22 is located at an x-coordinate x_{C}(t₁). In an image acquired at a time t₂, when camera 22 has an x-coordinate x_{C}(t₂), the feature will be imaged on a pixel having an x′-coordinate x′(t₂) which has a value given substantially by the expression
x′(t₂)=x′(t₁)+[(x_{C}(t₂)−x_{C}(t₁))/Zₒ]f, 1)
where Zₒ as noted above is the distance of scene 20 from camera 22 (the distance of the fronts of buildings 24 and 28 from camera 22), and f is the focal length of the camera's optical system. For the instant situation in which camera 22 is assumed to have a constant velocity V_{C}, the expression for x′(t₂) may be written
x′(t₂)=x′(t₁)+[(V_{C}(t₂−t₁))/Zₒ]f. 2)
In general, for an image 50 acquired by camera 22 at time t, the feature will be imaged at a pixel having an x-coordinate substantially given by the expression
x′(t)=x′ₒ+[(V_{C}t)/Zₒ]f, 3)
where x′ₒ is the location of the pixel at a time at which the feature is first imaged in the sequence of camera images 50. Between consecutive camera images 50, the x′-coordinate of an image of the feature in the images is displaced by an “image distance” Δx′ having a value given by
Δx′=[(V_{C}Δt)/Zₒ]f=ΔxM, 4)
where Δx is the distance between consecutive imaging positions noted above and M=f/Zₒ is a magnification of camera 22 for features at a distance Zₒ from the camera.

To illustrate the way in which the image x′ and y′-coordinates of pixels on which features in scene 20 are imaged behave, assume by way of example that features represented by points 91 and 92 in scene 20 have a same world y-coordinate in the scene. For a sequence of consecutive camera imaging positions 33 for which feature 91 or feature 92 is located within the field of view of camera 22, the feature is imaged on pixels in camera images 50 that have a same y′-coordinate. However, from one camera image 50 on which feature 91 or 92 is imaged to a next consecutive camera image on which the feature is imaged, the x′-coordinate of a pixel on which the feature is imaged changes by an amount Δx′=[(V_{C}Δt)/Zₒ]f.

Assume by way of example that EP plane 80 has y′-coordinate that corresponds to the world y-coordinate of features 91 and 92. All the pixels on which features 91 and 92 are imaged will lie on EP plane 80. Because camera 22 is moving at a constant velocity, a line, i.e. an EP trajectory line, through the pixels that image feature 91 or feature 92 will be a straight line having an equation of the form of equation 3.

In FIG. 1A, camera images 50 in which features 91 and 92 are imaged are indicated by brackets 93 and 94 respectively alongside the camera images. Pixels in the images on which features 91 and 92 are imaged lie on EP plane 80 and are schematically represented on the EP plane by points 95 and 96 respectively. Straight lines 97 and 98 through pixels 95 and 96 are EP trajectories of features 91 and 92 respectively. It is noted that EP trajectories 97 and 98 have a same slope because features 91 and 92 are located a same distance from camera 22 along the z-axis. It is further noted that EP trajectories 97 and 98 are straight lines because camera 22 is moving with constant velocity. Pixels 95, 97, and their respective EP trajectories 97 and 98 are more easily seen in FIG. 1B.

Assume that a physical distance between two consecutive camera images 50 along the t-axis that are acquired at times separated by the time interval Δt is substantially equal to a corresponding image distance Δx′=[(V_{C}Δt)/Zₒ]f=ΔxM. (i.e. equation 4). In a limit as time interval Δt approaches 0, and as a result density of camera images 50 goes to infinity, an image of mosaic plane 70 provides a continuous mosaic of scene 20.

A mosaic line and a corresponding mosaic strip comprising the mosaic line in an image of a scene acquired by a camera are defined as having an azimuth angle equal to an angle between the camera optic axis and a line in a plane perpendicular to the mosaic line that extends from the camera optic center to the mosaic line. The mosaic line has a 0° azimuth if the mosaic line intersects the camera's optic axis. A mosaic corresponding to a mosaic plane whose mosaic lines have a given azimuth angle is said to be a mosaic at the given azimuth angle. Mosaic lines 72 of mosaic plane 70 have an azimuth of 0° and an image of mosaic plane 70 therefore provides a mosaic at azimuth 0°. A mosaic plane displaced parallel to mosaic plane 70 has mosaic lines at a non-zero (positive or negative depending upon a direction in which the plane is displaced) azimuth angle, corresponding mosaic strips displaced from the centers of their respective camera images and therefore provides a corresponding mosaic at the non-zero azimuth angle.

However, as noted above, practically, density along the t-axis of camera images in a sequence of images of a scene is generally not sufficient to provide a continuous mosaic of the scene. Instead, in some methods the mosaic is generated by a mosaicing algorithm that determines for each camera image a finite width mosaic strip that includes pixels along the mosaic line in the camera image. The algorithm positions mosaic strips from consecutive camera images contiguous with each other to form the mosaic.

In FIG. 1A a mosaic strip 76 for each camera image 50 in ST volume 52 is indicated by a pair of boundary lines 71 and 73, one on either side of mosaic line 72 in the image. (Boundary lines are labeled with their numeral 71 and 72 only in the last camera image 50 in ST volume 50.) In order for a mosaic formed from mosaic strips 76 to provide a relatively continuous and motion distortion free representative image of scene 20, the finite widths of the mosaic strips are determined so that boundary line 73 of mosaic strip 72 from one camera image 50 and boundary line 71 of mosaic strip 72 from a next subsequent camera image 50, to an extent possible, image a substantially same line in scene 20.

From the discussion above with respect to the motion of pixels that image a feature in scene 20 it is seen that features imaged on mosaic line 72 of one camera image 50 are displaced a distance Δx′=−[(V_{C}Δt)/Zₒ]f in the next consecutive camera image 50. Therefore, in order for the mosaic to provide a continuous representative image of scene 20, mosaic strips 76 are chosen to have a width substantially proportional to [(V_{C}Δt)/Zₒ]f or ΔxM.

Mosaic strips 76 from consecutive camera images 50 are schematically shown placed contiguous to each other to form a mosaic 78 of scene 20. Features of scene 20 as they appear in mosaic 78 are schematically shown in an inset 79.

By way of example, exemplary mosaic 78 is generated for a very simple situation for which it is assumed that the ego motion of camera 22 is known and constant. Practically, mosaicing situations are in general substantially more complicated, even for situations in which the camera is moving along a substantially straight line. Camera ego motion is generally not constant and even if presumed known is subject to unknown perturbations. Unless properly addressed, unknown changes in camera ego motion of a camera used to acquire a sequence of images of a scene may, and generally will, generate substantial motion distortions in a mosaic of the scene produced from the images.

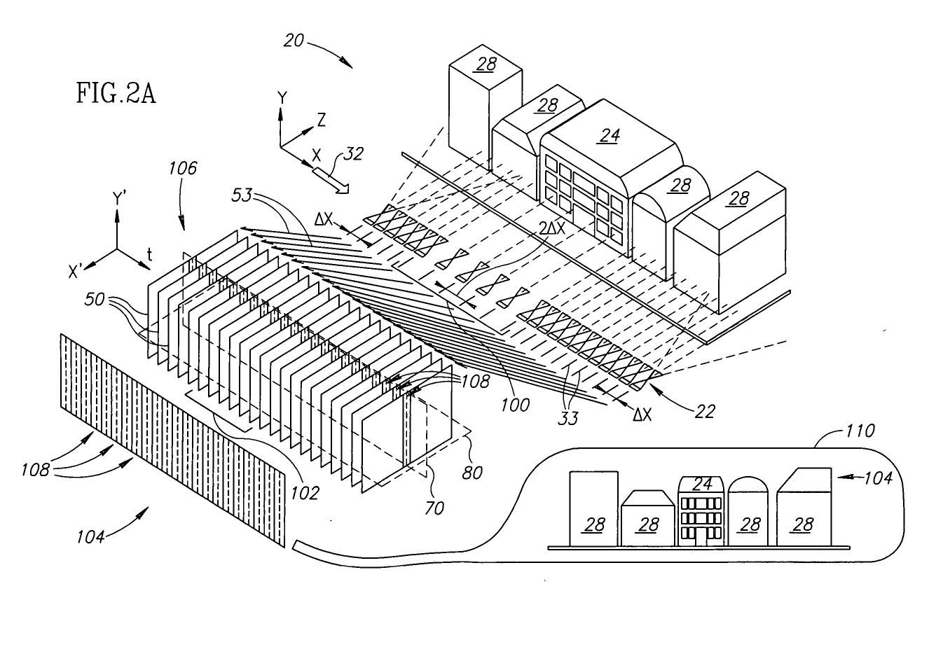

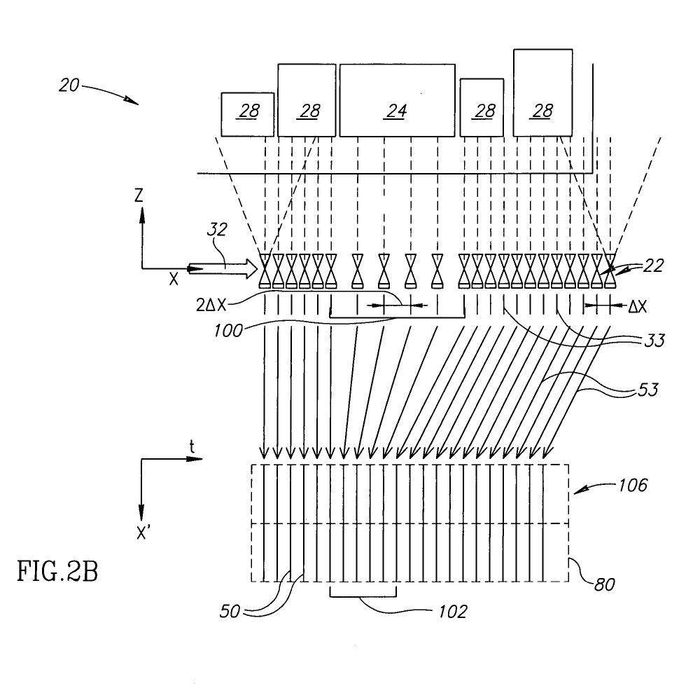

FIGS. 2A and 2B are schematic perspective and plan views of scene 20 that illustrate generating a mosaic from a sequence of camera images of the scene acquired by camera 22 for a case in which the camera undergoes an increase in speed along a portion of its path of motion that is unaccounted for in generating the mosaic.

As in the case shown in FIGS. 1A and 1B, camera 22 acquires camera images of scene 20 at regular time intervals Δt as it moves along the x-axis. For most of its motion along the x-axis, camera 22 moves with a constant velocity V_{C} and acquires camera images 50 of scene 20 at imaging positions 33, which are separated by a distance Δx=V_{C}Δt. However, along a portion of the x-axis, indicated by a bracket 100, opposite building 24, camera velocity is, by way of example, doubled. Along portion 100 camera 22 acquires camera images indicated by a bracket 102 at imaging positions separated by a distance 2Δx. Imaging positions indicated by bracket 100 and camera images indicated by bracket 102 are referred to as imaging positions 100 and camera images 102 respectively.

Under the mistaken assumption that velocity of camera 22 is everywhere constant, camera images 50 and 102 are processed to generate a mosaic 104 of scene 20 consistent with the camera images being arranged in an ST volume 106 similar to ST volume 52 (FIGS. 1A, 1B). In ST volume 106 each camera image 50 and 102 is separated from adjacent camera images by a temporal distance Δt, which corresponds to an image distance Δx′=[(V_{C}Δt)/Zₒ]f, and a mosaic 104 for scene 20 is generated from mosaic strips 108 having a width substantially equal to [(V_{c}Δt)/Zₒ]f=ΔxM. Arrows 53 in FIGS. 2A and 2B connect imaging positions 33 and 100 with their corresponding camera images 50 and 102 in ST volume 104.

However, positions of camera images 50 and 102 along the t-axis of ST volume 106 do not everywhere correspond to the imaging positions at which they were acquired. Whereas camera images 50 acquired at imaging positions 33 that are spaced apart by a real world distance Δx are properly spaced apart along the t-axis in ST volume 106, camera images 50 acquired at imaging positions 100, which are spaced apart by a distance 2Δx, are “clustered” too close to each other in the ST volume. Convergence of a portion of arrows 53 in FIGS. 2A and 2B, which convergence is most clearly shown in FIG. 2B, indicates clustering of camera images 50. Whereas a mosaic width equal to [(V_{c}Δt)/Zₒ]f is appropriate for mosaic strips 108 from camera images 50 acquired at imaging positions 33, the mosaic strip width is too small for mosaic strips 108 from camera images 102 acquired at “spread apart” imaging positions 100.

As a result, for a portion of mosaic 104 of scene 20 that is generated from mosaic strips 108 acquired at imaging positions 100 in which central building 24 is imaged, features in the mosaic will be distorted by narrowing. Furthermore, since mosaic strips 108 for camera images 102 are too narrow, features in a region of scene 20 opposite region 100 may in fact be missing from a portion of mosaic 104 generated from mosaic strips 108 that taken from camera images 102. However, in FIGS. 2A and 2B as noted above, it is assumed for simplicity that in general spacing between imaging positions 33 and 100 is substantially less than a distance parallel to the x-axis over which features in scene 20 undergo substantial change. As a result, features in scene 20 will in general not be missing in mosaic 104. Features of scene 20 as they appear in mosaic 104 are schematically shown in an inset 110 and the narrowing distortion of the mosaic is clearly shown in the narrowing of central building 24 and its features relative to buildings 28.

The narrowing may be understood by noting that a width of a feature in a mosaic may be approximated by a number of mosaic strips in which the feature appears times the width of the mosaic strips. (As noted above, the mosaic strips are assumed very narrow relative to features in scene 20.) FIGS. 2A and 2B, schematically show that in region 100 along the x-axis a number of imaging positions per unit path length is fewer than elsewhere. Features in scene 20 directly opposite region 100, i.e. central building 24, appear in less camera images, per unit length of the features along the x-axis, than features elsewhere. As a result, per unit length of the features along the x-axis, a number of mosaic strips in which the features appear is less than for features elsewhere in scene 20. Since mosaic strips 108 used to form mosaic 104 all have a same width, features opposite region 100 are narrowed relative to features elsewhere in the mosaic, i.e. building 24 is narrowed relative to buildings 28.

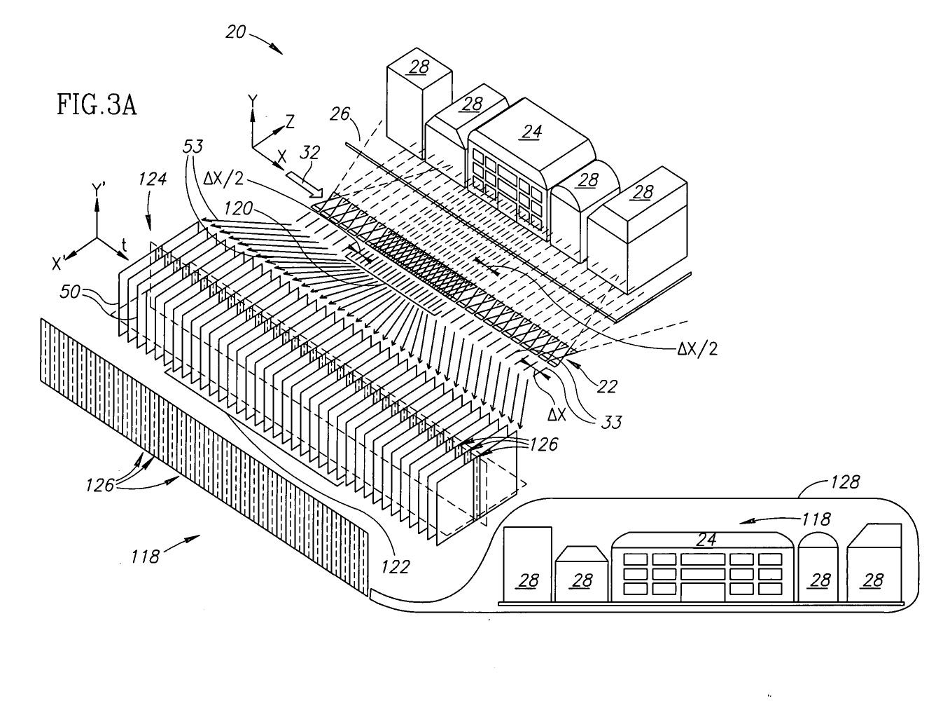

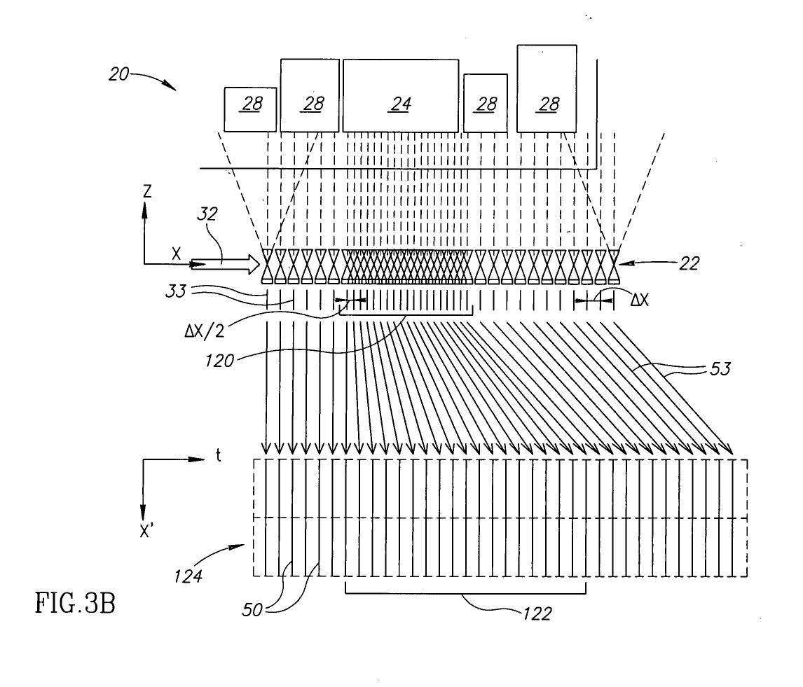

FIGS. 3A and 3B schematically illustrate generating a mosaic 118 of scene 20 that exhibits a motion distortion generated by a reduction in speed of camera 22 rather than an increase in speed. As a result, the motion distortion in mosaic 118 is a broadening distortion rather than the narrowing distortion exhibited by mosaic 104 shown in FIGS. 2A and 2B. FIGS. 3A and 3B schematically show respectively a perspective and plan view of scene 20.

As in the preceding examples, in FIGS. 3A and 3B camera 22 is assumed to move along the x-axis acquiring camera images of scene 20 at regular time intervals Δt. The camera moves along the x-axis with constant velocity V_{C} except for a region of the x-axis opposite central building 24 in which it moves with a velocity equal, by way of example, to V_{C}/2. A bracket 120 indicates the region in which camera velocity slows and imaging positions along the region are referred to as imaging positions 120. Outside of region 120 along the x-axis camera 22 acquires images 50 at imaging positions 33 that are separated by a distance Δx=V_{C}Δt. However, along region 120 camera 22 acquires images indicated by a bracket 122 that are separated by a distance Δx/2.

Under the assumption that velocity of camera 22 is constant, camera images 50 and 122 are processed to generate mosaic 118 from mosaic strips 126 that are consistent with the camera images being arrayed in an ST volume 124. In ST volume 124 a same spacing Δt along the t-axis that corresponds to an image distance, and mosaic strip width, Δx′=[(V_{C}Δt)/Zₒ]f separates all adjacent camera images.

Whereas camera images 50 are properly spaced one from the other in ST volume 124, camera images 122 acquired at imaging positions 120 are spaced too far apart relative to spacing between their imaging positions and are overly spread out in ST volume 124. And, whereas a mosaic width equal to [(V_{C}Δt)/Zₒ]f is appropriate for mosaic strips 126 from camera images 50, the mosaic width is too large for mosaic strips 126 from camera images 122 acquired at imaging positions 120. The spreading out of images 122 in ST volume 124 is indicated by a divergence of arrows 53 in FIGS. 3A and 3B, which divergence is most clearly shown in FIG. 3B.

As a result, for a portion of mosaic 118 that is generated from mosaic strips 126 acquired at imaging positions 120 and in which central building 24 is imaged, features in the mosaic are distorted by broadening. Whereas for the situation illustrated in FIGS. 2A and 2B, for region 100, the number of mosaic strips times the mosaic strip width is relatively too small, for the case illustrated in FIGS. 3A and 3B the number of mosaic strips times mosaic strip width for region 120 is too large. The inordinately large width of mosaic strips 126 in camera images 122 acquired for region 120 generates a broadening distortion of building 24 in mosaic 118. Furthermore, since mosaic strips 126 for camera images 122 are too broad, features in a region of scene 20 opposite region 120 may in fact be duplicated, or exhibit “ghosting”, in a portion of mosaic 118 generated from mosaic strips 126 that taken from camera images 122. However, since it is assumed for simplicity that, in general, spacing between imaging positions 33 and 120 is substantially less than a distance parallel to the x-axis over which features in scene 20 undergo substantial change, ghosting of features will in general not be evident in mosaic 118. Features of scene 20 as they appear in mosaic 118 are schematically shown in an inset 128 and broadening distortion of the mosaic is clearly shown in the broadening of central building 24 and its features relative to buildings 28.To obviate the motion distortions in a mosaic illustrated in FIGS. 2A-3B, prior art algorithms, such as 2D methods, typically generate the mosaic responsive to the locations of a common feature or features, hereinafter “fiducial features”, in the camera images. For example, assume that a mosaicing algorithm locates a common fiducial feature, for example a comer of a prominent building or a lamppost in a street scene, in two consecutive camera images in a sequence of images being used to generate a mosaic of a scene. A difference between the x′-coordinates of pixels that image the feature in the two images provides a value for an image distance Δx′ that corresponds to a spacing between the imaging positions at which the images are acquired and consequently for a width for mosaic strips from the images.

As may be inferred from equation 4), for a relatively flat scene, such as scene 20 shown in FIGS. 1A-3B for which features of the scene are substantially at a same distance Zₒ from camera 22, image distances Δx′ between consecutive camera images determined from fiducial features are proportional to spacing between imaging positions. For consecutive images for which the imaging positions are relatively far apart, relatively wide mosaic strips are determined, while for images for which imaging positions are relatively close, relatively narrow imaging strips are determined. For flat scenes determining mosaic strip widths responsive to fiducial features therefore, generally, substantially reduces motion distortions of the type illustrated in FIGS. 2A-3B.

However, for a scene exhibiting substantial depth variation, different fiducial features identified by a fiducial mosaicing algorithm, or any other prior art 2D method, may be located at substantially different depths (i.e. different z values in equation 4)) relative to the camera. For consecutive imaging positions separated by a same distance, fiducial features at different depths provide different image distances Δx′. Mosaic strip widths determined from motion of different fiducial features therefore may not properly correspond to spacing between imaging positions. As a result, widths of mosaic strips for camera images acquired at the imaging positions may be substantially in error and a mosaic generated from the mosaic strips distorted. In particular, different regions of a same feature in a scene may be imaged in the mosaic using different width mosaic strips resulting in the feature exhibiting substantial deformation in the mosaic.

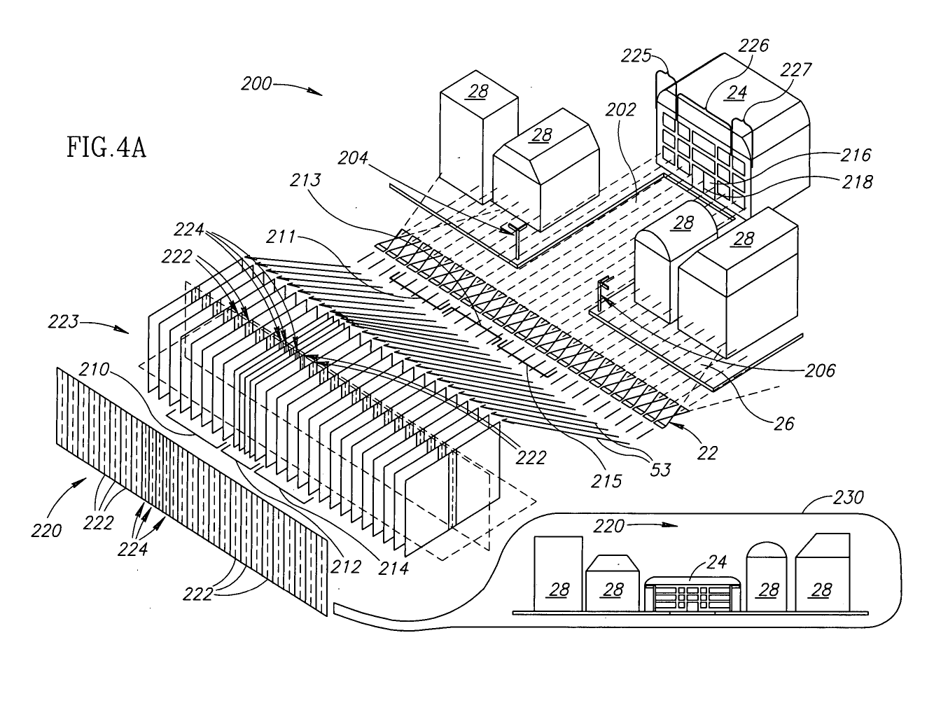

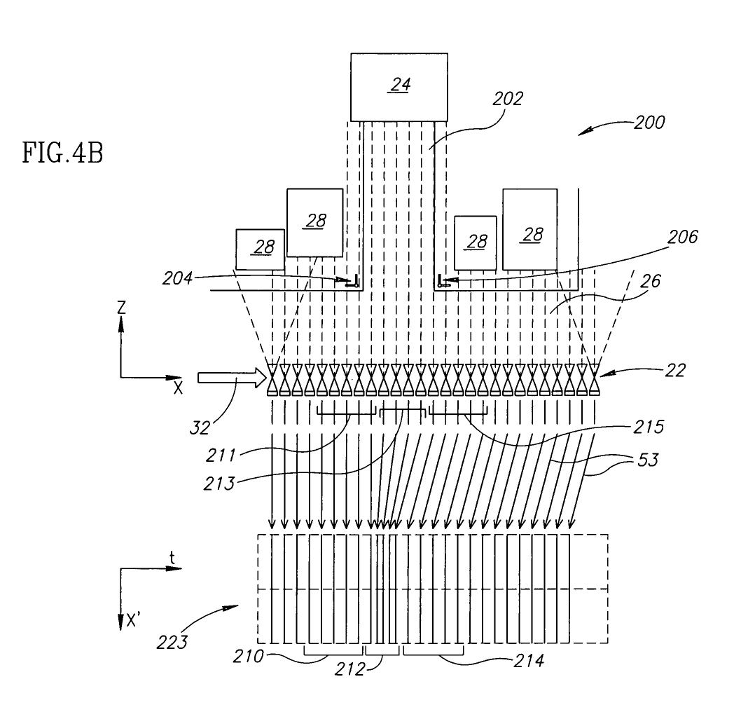

FIGS. 4A and 4B show schematic perspective and plan views respectively of a scene 200 having substantial depth variation and illustrate typical motion distortions in a mosaic of the scene generated in accordance with a prior art 2D method such as a “fiducial algorithm”.

Scene 200 is similar to scene 20 but has central building 24 at the end of a street 202, set back from the row of buildings 28 along street 26. Street signs 204 and 206 are located at opposite comers of the junction of streets 26 and 202. Camera 22 is assumed to move along the x-axis with a constant velocity V_{C} acquiring a sequence of camera images of scene 200 at time intervals Δt.

Camera 22 acquires camera images of scene 200 that are indicated by a bracket 210, which are referred to as camera images 210, at imaging positions indicated by a bracket 211, hereinafter imaging positions 211. The camera acquires camera images of scene 200 that are indicated by a bracket 212, which are referred to as camera images 212, at imaging positions indicated by a bracket 213, hereinafter imaging positions 213. At imaging positions 215 indicated by a bracket 215, camera 22 acquires images 214 indicated by a bracket 214.

By way of example, a mosaic 220 of scene 200 is assumed to be generated by a prior art fiducial algorithm that identifies street sign 204 as a fiducial feature for camera images 210 and street sign 206 as a fiducial feature for camera images 214. For camera images 212 the algorithm is assumed to identify doors 216 and in particular a boundary 218 between the doors as a fiducial feature. Street signs 204 and 206 are assumed to have a z-coordinate Zₛ and boundary 218 a z-coordinate Z_{d}. Fiducial features for other camera images acquired of scene 200 by camera 22 are assumed, for simplicity of discussion, to have a z-coordinate which is also equal to Zₛ.

For camera images 210 and 214 the algorithm defines mosaic strips 222 having a mosaic strip width Δx′ₛ=[(V_{C}Δt)/Zₛ]f from which to generate mosaic 220. For images 212 the algorithm defines mosaic strips 224 having a mosaic strip width Δx′_{d}=[(V_{C}Δt)/Z_{d}]f from which to generate mosaic 220. (Note that unlike in FIGS. 1A-3B for which mosaic strips are determined from a known or an assumed (but mistaken) camera velocity, in FIGS. 4A and 4B mosaic strip width is determined using data from the images without knowing or assuming a camera velocity.) For other camera images, mosaic strip width is the same as that for mosaic strips 222. In scene 200 is assumed for convenience of presentation that Zₛ=Z_{d}/2 and that therefore Δx′ₛ=2Δx′_{d} (It is noted that width of mosaic strips 224 from first and last camera images 212 is generally larger than Δx′_{d} because of the larger spacing between the first and last camera images and adjacent camera images 210 and 214 respectively. Furthermore, mosaic strips 224 (or 222) other than those from the first and last camera images 212 do not all have to have the same width. For example, a given strip may be wider than a neighboring strip at the expense of the neighboring strip, which is made correspondingly narrower. Such differences and other similar differences that are conventionally encountered in generating a mosaic are ignored to simplify the discussion.)

Whereas adjacent imaging positions of camera 22 are everywhere equally spaced by a distance, Δx=V_{C}Δt, and therefore to generate a mosaic relatively free of motion distortions, mosaic strips from all images acquired by the camera should have a same width, the prior art 2D algorithm in fact generates different mosaic strip widths for different camera images. The algorithm generates mosaic 220 consistent with an ST volume 223 in which camera images 212 cluster too close to each other relative to the spacing between the other camera images acquired by camera 22. Width of mosaic strips 222 from images 210 and 214 have a width twice that of mosaic strips 224 defined for camera images 212 (Δx′ₛ=2Δx′_{d}). The temporal locations along the t-axis in ST volume 223 of images acquired by camera 22 do not have a same correspondence to their respective imaging positions and are not everywhere proportional to their corresponding imaging positions with a same proportionality constant. As a result, mosaic 220 exhibits substantial motion distortion.

In particular, different regions of building 24 are imaged in mosaic 220 using different width mosaic strips. A central portion of building 24, indicated by a bracket 226, is imaged in mosaic 220 using mosaic strips from camera images 212 having a mosaic width Δx′_{d}. On the other hand, mosaic strips 222 having a mosaic width Δx′ₛ which is larger than Δx′_{d} are used to image lateral portions of building 24, indicated by a brackets 225 and 227, in the mosaic. As a result, building 24 is substantially distorted in mosaic 220. Lateral portions 215 and 217 of building 24 are substantially broadened relative to central portion 216 of the building and buildings 28 in mosaic 220. The distortion of building 24 is readily seen in inset 230, which shows features of scene 200 in mosaic 220.

It is noted that the height of building 24 in mosaic 220 is substantially less than that of buildings 28 whereas in reality building 24 is about the same height as the other buildings. The relative height decrease of building 24 is due to building 24 being farther from camera 22 than buildings 28 and perspective of features in scene 200 being preserved along the y-axis, i.e. the height-axis in mosaic 220. In general, a mosaic produced from images of a scene acquired by a moving camera preserves perspective in a direction perpendicular to the direction of motion of the camera but not along the direction of motion of the camera. This typically leads to an inherent decrease in vertical dimensions of features in the scene imaged in the mosaic relative to horizontal dimensions of the features and an inherent broadening of the features in the mosaic.

In accordance with an embodiment of the present invention, a mosaic of a scene is generated from a sequence of camera images of the scene acquired by a translating camera consistent with the images being arrayed in a “time-warped” ST volume. In the time warped ST volume, the camera images in the sequence are spaced along the t-axis of the ST volume so that EP trajectories of features in the scene are straight lines. The time positions of the images are not necessarily the actual times at which the images are acquired but are times that are adjusted, or warped, to provide the straight-line EP trajectories. The adjusted times are referred to as warped times as noted above.

The inventors have noted that for a feature in a scene at a substantially constant distance from the focal plane of a translating camera that acquires a sequence of images of the scene, the coordinates of a pixel in the images that images the feature are linear functions of the world coordinates of the camera. The linearity is independent of the speed or changes therein with which the camera translates. In particular, as may be concluded from equation 4), if the camera is moving along the x-axis as for example, in the scenario illustrated in FIGS. 4A-4B, the x′-coordinate of pixels in camera images that image the feature is a linear function of the x-coordinate of the imaging positions at which the images are acquired.

Therefore, if camera images of a scene in a sequence of camera images acquired by a camera moving along the x-axis are arrayed along the t-axis of an ST volume at t-coordinates that are proportional to the x-coordinates of imaging positions at which the camera images are acquired, EP trajectories of features in the image are straight lines. Conversely, assume that camera images of a scene in a sequence of images acquired by a camera translating along the x-axis are arrayed along the t-axis of an ST volume at warped t-coordinates for which EP trajectories of features in the scene are straight lines. Then the warped t-coordinates of the images are proportional to the x-coordinates of the imaging positions of the camera at which the images are acquired. As a result, a difference between the warped t-coordinates of any two consecutive camera images in the ST volume is proportional to the difference between the x-coordinates of the camera imaging positions at which the images are acquired.

A mosaic generated, in accordance with an embodiment of the invention, responsive to the warped times will therefore more accurately reflect the actual imaging positions of the camera than a mosaic generated in accordance with conventional prior art algorithms. As a result the mosaic will, generally, be less compromised by motion distortions common in prior art mosaics.

In some embodiments of the invention the mosaic is generated by generating values for intermediate pixels at locations between mosaic lines in a mosaic plane of the ST volume. The intermediate pixel values are generated responsive to the warped time intervals and values of pixels in the camera images using any of various methods and algorithms known in the art. In some embodiments of the present invention the mosaic is generated from mosaic strips having widths determined responsive to the warped times. By way of example, in the discussion below it is assumed that the mosaic is generated from mosaic strips.

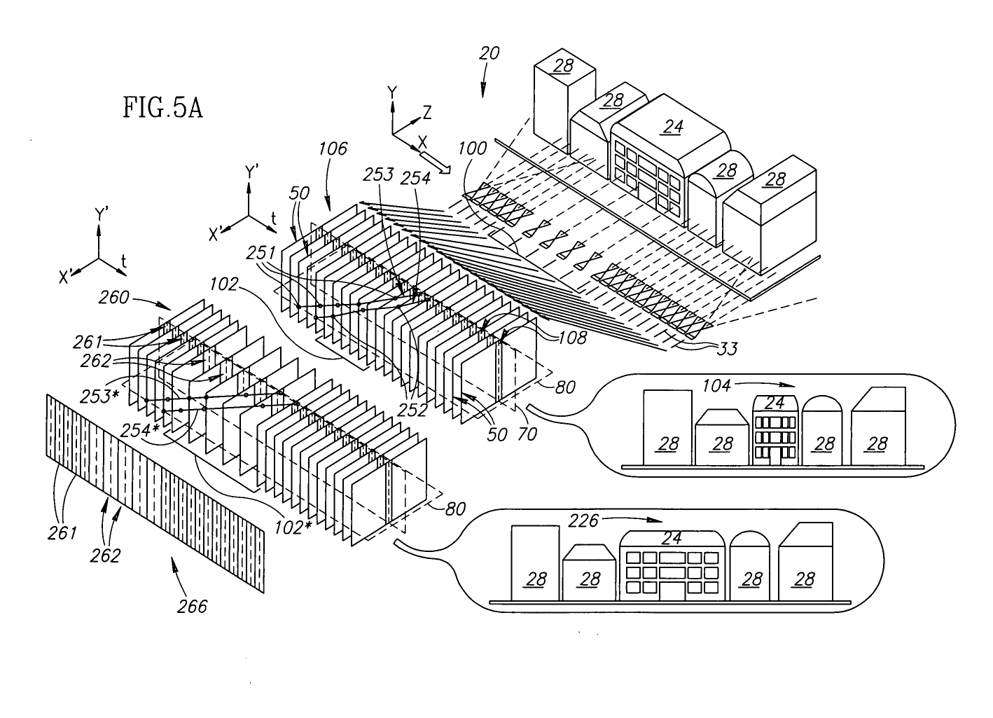

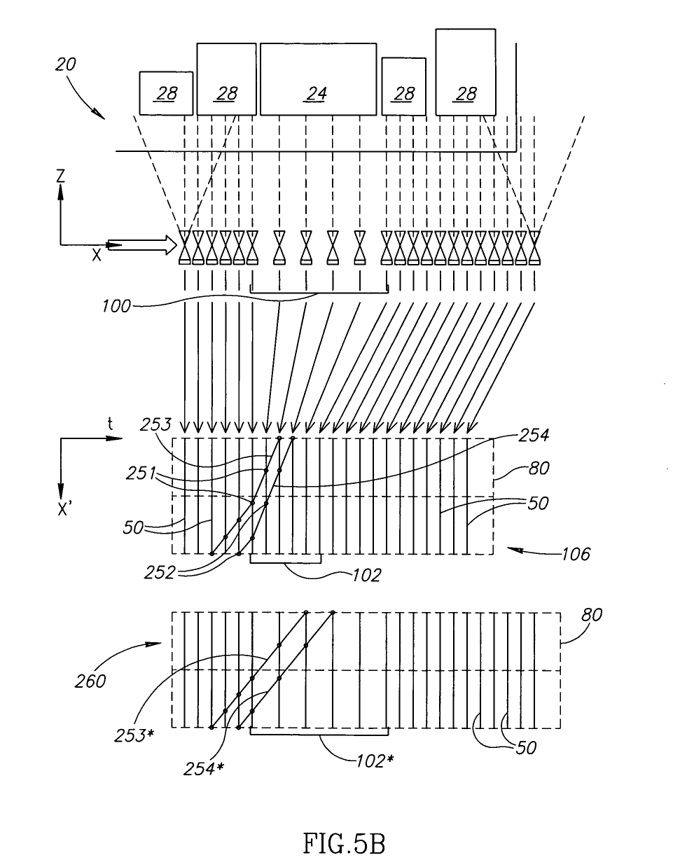

FIGS. 5A and 5B are perspective and plan views respectively of scene 20 shown in FIG. 2A that illustrate generating a mosaic of the scene from mosaic strips that is relatively free of motion distortion, in accordance with an embodiment of the present invention.

FIGS. 5A and 5B show features of FIGS. 2A and 2B and in addition show for ST volume 106 shown in FIGS. 2A and 2B pixels 251 and 252 in EP plane 80 of the ST volume. Pixels 251 and 252 respectively image features 91 and 92 in camera images 50 and 102 (indicated by bracket 102) acquired of scene 20 by camera 22. Also shown are EP trajectories 253 and 254 defined by pixels 251 and 252.

As a result of the clustering of camera images 102, as noted in the discussion of FIGS. 2A and 2B, mosaic strips 108 determined for camera images 102 in accordance with prior art are too narrow and result in the narrowing distortion of building 24 in mosaic 104 generated from the strips. The clustering of camera images 102 also results in EP trajectories 253 and 254 not being straight lines.

However, if the times of camera images 50 and 102 along the t-axis are warped, in accordance with an embodiment of the invention, so that EP trajectories and 253 and 254 are morphed into straight lines, the temporal spacing between any two consecutive camera images acquired by camera 20 becomes proportional to the distance between their associated imaging positions. Mosaic strips having widths determined proportional to differences between the warped times, in accordance with an embodiment of the invention, will therefore have widths proportional to the distances between imaging positions at which the images are acquired and a mosaic generated from the mosaic strips will, exhibit substantially no motion distortion.

Camera images 50 and 102 are schematically shown positioned in an ST volume 260 at warped times that morph EP trajectories 253 and 254 into straight-line EP trajectories 253* and 254*. In ST volume 260 a bracket 102* indicates camera images 102 located at their warped times. From the figures, it is seen that temporal distances along the t-axis between camera images 50 and 102 in ST volume 260 are proportional to distances between their corresponding imaging positions 33 and 100. The proportionality between warped times and camera positions is most clearly seen in the plan view shown in FIG. 5B. Mosaic strips 261 and 262 for camera images 50 and 102 respectively have their widths determined, in accordance with an embodiment of the invention, proportional to the warped temporal differences between adjacent camera images. The widths are therefore also proportional to differences between corresponding adjacent camera image positions 33 and/or 100.

In particular, for images 102, for which in ST volume 106 temporal spacing is too small relative to spacing of corresponding imaging positions 100 of camera 22, in ST volume 260 temporal spacing is increased and is proportional to spacing of corresponding imaging positions 100 of the camera. Widths of mosaic strips 262 for camera images 102 are also increased and proportional to the spacing between corresponding image positions 100.

FIG. 5A schematically shows mosaic strips 261 and 262 arrayed to form a mosaic 266 of scene 20. The increased width of mosaic strips 262 relative to the widths of mosaic strips 108 in ST volume 106 substantially removes from mosaic 266 the narrowing distortion of building 24 that degrades mosaic 104. Scene 20 as it appears in mosaic 104 and in mosaic 266 is shown in insets 267 and 268 respectively, and the removal of the narrowing distortion of building 24 from mosaic 266 is clearly seen by comparing the appearance of scene 20 in the two insets.

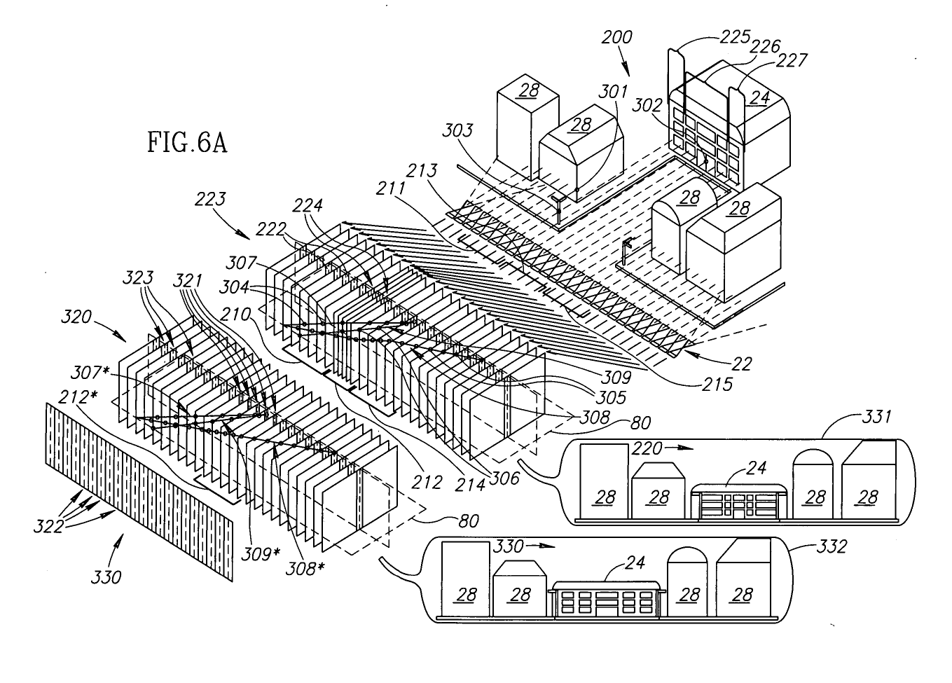

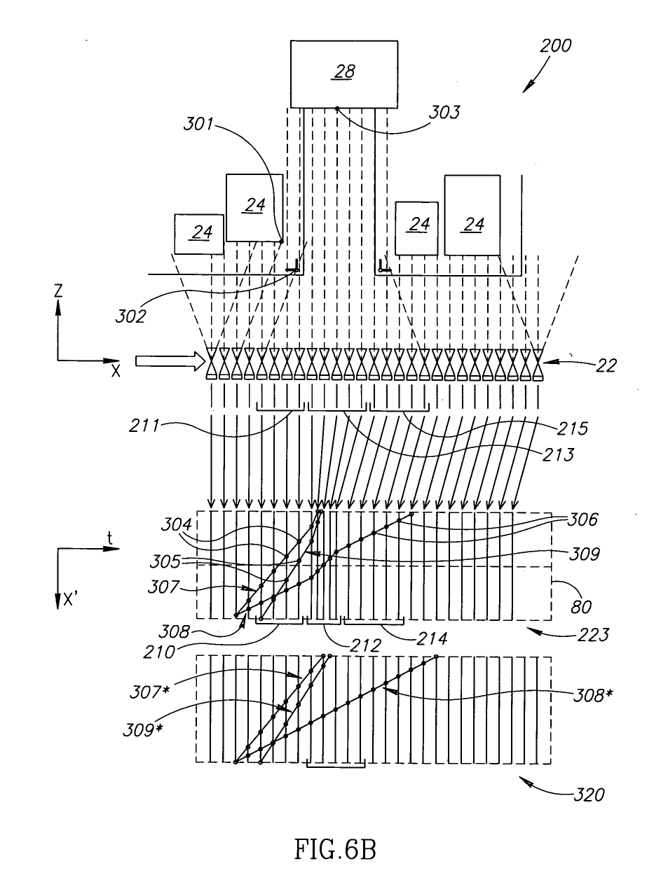

Similarly to the way in which a method in accordance with an embodiment of the present invention removes the narrowing motion distortion evidenced in mosaic 104, the method also removes the broadening motion distortion exhibited in mosaic 118 shown in FIG. 3A. For the scenario illustrated in FIG. 3A the method determines widths for mosaic strips 122, which image building 24, that are narrower than those determined in the illustrated scenario and thereby removes the broadening distortion of the building. Prior art 2D methods, such as various fiducial based algorithms, also remove the motion distortions exhibited in FIGS. 2A-3B. However, these prior art methods do not remove the motion distortions illustrated in FIGS. 4A and 4B, which are removed in accordance with an embodiment of the invention, as discussed below with reference to FIGS. 6A and 6B.

It is noted that the constraint in accordance with an embodiment of the invention that warped temporal times of camera images in an ST volume be such that EP trajectories in the ST volume are straight lines, does not competently determine the warped times. The constraint determines the warped times only to within a constant factor. However, it does determine the relative differences between the warped temporal times of the camera images and therefore determines the relative spacing of mosaic lines in a mosaic plane and therefore relative widths of mosaic strips to be used in accordance with an embodiment of the invention to generate a mosaic of a scene.

Alternatively, in accordance with an embodiment of the invention, in which mosaic strips are not used to generate a mosaic, the warped times provide relative temporal differences between camera images, or relative spacing of mosaic lines for use in generating a mosaic by generating pixel values for intermediate pixels.

Any of various procedures may be used to determine a proportionality factor, hereinafter a “warp factor” (WF), between time warped acquisition times of the camera images and widths of mosaic strips corresponding to x-coordinates of imaging positions at which the images are acquired. For example, if the speed of motion of camera 22 along a portion of the x-axis and the z-coordinate of features in the scene imaged by the camera as it moves along the x-axis portion known, the warp factor may be estimated as being equal to the known speed times the magnification M (i.e. f/Z, where Z is the z-coordinate of the features) of the camera. Or, a warp factor may be determined to preserve a known aspect ratio of a feature or features located at a known distance from the camera by requiring that EP trajectories of the feature or features have a slope approximately equal to 45° for warped times corrected by the warp factor. Alternatively, a 2D method may be used to estimate WF from motion of an image of a fiducial feature in camera images acquired by camera 22, the focal length f and range Z_{R} of the field of view of the camera. For example, let a difference between the warped acquisition times of two camera images be “Δt_{w}”, and assume that x′-coordinate of the image of the fiducial feature moves a distance Δx′_{F} in the camera images then, optionally, WF=(Δx′_{F}/Δt_{w}).

Once determined, the warp factor may be used, in accordance with an embodiment of the invention, to determine widths of mosaic strips for the camera images that are used to generate a mosaic. Let a difference between the warped acquisition times of two consecutive images be “Δt_{w}” then a mosaic strip width, “MSW”, for the images may be written:
MSW=Δt_{w}WF. 5)

It is noted that since the straight line constraint determines warped times only to within a constant factor, a mosaic of an image generated in accordance with an embodiment of the invention may be distorted by a scale factor along the direction of translation of a camera that acquires a sequence of images from which the mosaic is generated. However, a mosaic in accordance with an embodiment of the invention is generally more immune to a motion distortion in which different regions of a same feature in the scene are scaled differently. Such a distortion, exhibited by way of example in FIGS. 4A and 4B, is frequently encountered in mosaics of scenes characterized by relatively large depth variations that are generated by prior art fiducial mosaicing algorithms.

FIGS. 6A and 6B schematically show how the distortion in mosaic 220 of scene 200 shown in FIGS. 4A and 4B is moderated by generating the mosaic in accordance with an embodiment of the present invention.

FIGS. 6A and 6B are schematic perspective and plan views of scene 200 that comprise FIGS. 4A and 4B respectively and in addition show pixels in EP plane 80 of ST volume 223 that image features 301, 302 and 303 in scene 200 on camera images acquired by camera 22. Pixels 304, 305 and 306 in the camera images respectively image features 301, 302 and 303. Also shown are EP trajectories 307, 308 and 309 defined respectively by pixels 304, 305 and 306. Features 301, 302 and 303, corresponding pixels 304, 305 and 306 and their respective EP trajectories 307, 308 and 309 are more clearly shown in FIG. 6B.

In ST volume 223 camera images 212 are clustered as described in the discussion of FIGS. 4A and 4B. As a result of the clustering mosaic strips 224 of camera images 212 are narrower than mosaic strips 222 of camera images 210 and 214, and in mosaic 220 lateral regions 225 and 227 of building 24 are substantially magnified relative to central region 226 of the building. The clustering also results in EP trajectories, such as EP trajectories 307, 308 and 309, of features in scene 200 not being straight lines (more clearly shown in FIG. 6B).

In an ST volume 320, camera images acquired by cameras 22 are located, in accordance with an embodiment of the invention at times along the t-axis of the ST volume that are warped so that trajectories 307, 308 and 309 are morphed into straight trajectory lines 307*, 308* and 309* respectively. The warped times of the camera images are proportional to the x-coordinates of the respective corresponding imaging positions at which the images are acquired by camera 22 and clustering of camera images 212 in ST volume 223 is removed in ST volume 320. Since in FIGS. 4A and 4B and in FIGS. 6A and 6B velocity of camera 22 does not change, and the camera takes images of scene 200 at same regular intervals the camera images in ST volume 320 are equally spaced and a same warped time interval separates any two adjacent camera images in the ST volume. A mosaic 330 of scene 200 is schematically shown generated from mosaic strips 322, and since, in accordance with an embodiment of the invention, all adjacent camera images of scene 200 in ST volume 320 are spaced apart by a same warped time interval, all the mosaic strips have a same mosaic strip width.

In the above discussion, it has been tacitly assumed that a mosaic strip used in generating a mosaic is the same as and identical to a strip of data comprised in a corresponding camera image. However, a mosaic strip in accordance with the present invention is not necessarily identical to a strip of data taken from a corresponding camera image and, similarly to prior art mosaic strips, may have dimensions that are different from dimensions of a region in a corresponding camera image from which data is taken to “fill” the mosaic strip. In prior art it is known to scale data taken from a region of a camera image that is larger or smaller than a mosaic strip to “fill” a mosaic strip so as to reduce image artifacts such as ghosting or loss of features, as noted above.

In particular, after width of a mosaic strip is defined, in accordance with the present invention, image data that fills the mosaic strip may be taken from a region of a corresponding camera image that has a width different from the mosaic strip. For example, as noted above, the warp factor WF in equation 5) is defined for a particular z-coordinate. For regions in the scene having a z-coordinate greater than the “warp z-coordinate”, features in the regions will be duplicated along edges of adjacent mosaic strips in a mosaic if the strips in the camera images that correspond to and “fill” the mosaic strips have a same width as the mosaic strips. As a result the mosaic will be degraded by “ghosting” of the features along the mosaic strip edges. On the other hand, for regions in the scene having a z-coordinate less than the warp z-coordinate, features in the regions that should appear in the neighborhood of edges of adjacent mosaic strips will be missing if data in the camera images that fill the mosaic strips are taken from strips in the camera images having widths equal to the mosaic strips. As a result, the mosic may exhibit discontinuities at strip boundaries.

Therefore, in accordance with an embodiment of the invention, data from a camera image that is used to fill a corresponding mosaic strip is optionally taken from a camera image strip having a width that is substantially equal to the mosaic strip width times a ratio between the warp z-coordinate and the z-coordinate of features in the strip. If the warp z-coordinate is represented by Z_{W} and the z-coordinate of a region of the scene is represented by Z_{R} then data to fill a mosaic strip having a width given by equation 5) that images a portion of the region in a mosaic is taken from a corresponding camera image strip having a width given by,
MSW=[Δt_{w}WF](Z_{W}/Z_{R}). 6)

Since data acquired for a mosaic strip from a camera image strip having a width different from the mosaic strip does not fit the mosaic strip the data from the camera image strip is “rescaled” to fit the mosaic strip width. By taking data from camera image strips adjusted for the z-coordinates of region of a scene, in accordance with an embodiment of the invention, ghosting and feature loss in the mosaic generated from the mosaic strips is substantially removed.

For scene 200, by way of example, the distance of building 24 from camera 22 is about twice that of building 28 from the camera. Therefore, whereas all mosaic strips 322 in mosaic 330 have a same width, camera image strips indicated by numeral 321 that image building 24 in camera images 212* have half the width of other camera image strips 323 in the ST volume. To fit corresponding mosaic strips 330 in mosaic 330, width of camera strips 321 is scaled up by a factor of two.

It is noted that in mosaic 220 of scene 200 generated in accordance with an exemplary prior art fiducial mosaicing algorithm, different regions of building 24 are imaged in the mosaic with different width mosaic strips resulting in substantial distortion of the building in the mosaic. Mosaic 230, which is generated in accordance with an embodiment of the invention, correctly determines relative mosaic widths and does not exhibit the distortion exhibited by mosaic 220. Scene 200 as it appears in mosaics 220 and 330 is shown for comparison in insets 331 and 332 respectively. Dimensions of all features of building 24 in mosaic 330, in accordance with the invention, are correctly scaled along the x-axis scaled relative to each other. The relative reduction in height of building 24 in mosaics 220 and 330 is as noted above the result of conservation of perspective in the y direction.

Aligning camera images in a sequence of camera images of a scene comprised in an ST volume so that EP trajectories defined by pixels in at least one EP plane of the ST volume are straight lines, in accordance with an embodiment of the invention, may be performed using any of many different possible methods, including those described below.

In some embodiments of the invention, warped t-coordinates are determined by requiring that they optimize a global measure having a value that is indicative of an extent to which an image of an EP or images of EP planes comprise straight lines. For example, a global measure may be the entropy of a Fourier or Radon transform of the image at least one EP plane. Fourier and Radon transforms have relatively small entropy when applied to an image whose features are dominated by straight-line features.

In some embodiments of the invention, an iterative method such as that described in U.S. Provisional Application 60/524,675 and U.S. Provisional Application 60/552,393 cited above, the disclosures of which are incorporated herein by reference is used.

In one such method, an arbitrary warped time difference between warped times t₁ and t₂ corresponding respectively to first and second camera images I₁ and I₂ comprised in an ST volume is determined. At least one suitable “fiducial” region (for example an x′y′ region) in I₂ having a relatively easily identifiable feature or characteristic, such as a region in which the gradient of the image is relatively large (e.g. a region comprising a border), is then identified. A line (not necessarily a trajectory line in an EP plane) is determined that extends from the at least one fiducial region in image I₂ and intersects image I₁ in a region, as determined using a suitable matching criterion, such as a least square criterion, that is most similar to the fiducial region. A warped time is then determined for an image I₃ by requiring that the line intersect image I₃ in a region most similar as per a suitable matching criterion to the fiducial region in image I₂. The process is then used to determine a warped time for an image I₄. At least one fiducial region is determined in image I₃ and for each of the at least one fiducial region a line that intersects at least one of the preceding images I₂ and I₁ in a region most similar to the fiducial region. The lines determined for the at least one fiducial region in I₃ is used to determine a warped time t₄ for image I₄ by requiring that the line intersect region in I₄ that most closely resembles the at least one fiducial region in I₃. The process is repeated as necessary to determine warped times for other camera images in the ST volume.

In some embodiments groups of pixels in each of at least one EP plane of the ST volume that image same features in the scene and belong to same convenient EP trajectories may be identified using any of various feature tracking methods known in the art, such as those described in U.S. Pat. No. 6,683,968, U.S. Pat. No. 6,035,067 or U.S. Pat. No. 6,507661, the disclosures of which are incorporated herein by reference. Once identified, at least one of any of various methods may be used to determine warped t-coordinates of the camera images that morph the EP trajectories into straight-line trajectories, in accordance with an embodiment of the present invention.

Optionally, an iterative method similar to the iterative method described above is used, in which warped t-coordinates for successive camera images in the sequence of camera images are determined responsive to straight-line EP trajectories determined for preceding camera images.

Assume that the sequence of images comprises N images Iᵢ. Optionally, the method determines a “preferred” slope for each EP trajectory from pixels that define the trajectory in an initial subset of m optionally consecutive camera images, {Iᵢ|(n−m)≦i<n−1} in the sequence of camera images. Any of various methods known in the art may be used to determine the preferred slopes. Optionally, the preferred slopes are determined using a best-fit algorithm assuming the m images in the initial subset are temporally equally spaced. Optionally, the preferred slopes are determined using a stereo matching algorithm such as described in U.S. Pat. No. 6,487,304, the disclosure of which is incorporated herein by reference. Optionally, the slopes are determined using a method similar to that in an article by Z. Zhu, G. Xu, and X. Lin, “Panoramic EPI Generation and Analysis of Video from a Moving Platform with Vibration”, IEEE Conf. CVPR, 1999, pp. 2531-2537, which uses a Fourier transform as a “slope detector”.

The pixels in the previous m camera images and preferred slope associated with each EP trajectory define a preferred, straight-line EP trajectory for the EP trajectory. A warped t-coordinate, tₙ for an n-th camera image is determined so that so that, as determined subject to a suitable matching criterion, distances between pixels in the n-th camera image and the preferred straight-line trajectories associated with their respective EP trajectories are minimized. After time tₙ is determined for the n-th camera image, optionally, a new preferred straight-line EP trajectory is determined for each EP trajectory having a pixel in the (n+1)-st camera image from pixels in at least some of the (m+1) camera images comprising the m initial camera images and the n-th camera image. A warped time t₍ₙ₊₁₎ is determined for the (n+1)-st camera image using the new preferred straight line EP trajectories similarly to the way in which the previous preferred trajectories were used to determine warped time tₙ.

The procedure is optionally repeated thereafter in the “forward direction” until a warped time is determined for camera images I₍ₙ₊₂₎ to I_{N}. The procedure is repeated in the “backward direction” to determine warped times for images I₍ₙ₋₂₎ to I₁ optionally using an initial set of m camera images I₍ₙ₋₁₎ to I₍ₙ₊ₘ₋₂₎. (It is noted that in the above described procedure warped times are, optionally, not initially determined for the initial set of camera images {Iᵢ|(n−m)<i<n−1} when applying the procedure in the forward direction.)

It is noted that whereas in the above exemplary method the initial set of m images comprised consecutively indexed images the initial set does not have to comprise consecutively numbered images. For example the initial set may comprise images having randomly chosen indices. Similarly, the warped times do not have to be determined for consecutively indexed images. For example, after determining a warped time tₙ is determined, a warped time t_{q}, q≠(n+1) may be determined for an I_{q}-th camera image.

Let a pixel in camera image Iᵢ at image coordinates x′,y′ have a pixel value, e.g. a gray level, represented by Iᵢ(x′,y′). Iᵢ(x′,y′) is also used to identify the pixel in image Iᵢ at image coordinates x′,y′. A warped time interval Δt between first and second images, such as images I₍ₙ₋₁₎ and Iₙ, in the sequence of images {Iᵢ|1≦i≦N}, may. be determined, in accordance with an embodiment of the invention, by minimizing a “gradient” error function “Err(Δx′,Δy′)” defined by the following expression,

$$\begin{matrix}Err ( Δ {x}^{′} , Δ {y}^{′} ) = {\sum }_{( {x}^{′} , {y}^{′} ) ∈ R} [ Δ {x}^{′} \frac{\partial {I}_{n - 1}}{\partial {x}^{′}} + Δ {y}^{′} \frac{\partial {I}_{n - 1}}{\partial {y}^{′}} + \\ { {I}_{n} ( {x}^{′} , {y}^{′} ) - {I}_{n - 1} ( {x}^{′} , {y}^{′} ) ]}^{2} .\end{matrix} \qquad 7 )$$

In the expression for Err(Δx′, Δy′), R represents a region in images Iₙ and Iₙ₋₁, and Δx′ and Δy′are displacements along the x′ and y′ image coordinate-axes respectively of pixel Iₙ₋₁(x′,y′) caused by motion of the camera between imaging positions at which camera images Iₙ and Iₙ₋₁ are acquired.

For the scenarios schematically shown in FIGS. 1A-6B, camera 22 is assumed to move only along the x-axis. Therefore, for these scenarios Δy′=0 and in accordance with an embodiment of the invention, Δx′=S(x′,y′)Δt, where S(x′,y′) is the slope of the trial straight line EP trajectory that is associated with the pixel Iₙ(x′,y′). Setting Δx′=S(x′,y′)Δt and Δy′=0 in equation 7) and minimizing the expression provides a value for Δt, and since tₙ₋₁ is assumed known, also for tₙ.

In some embodiments of the invention it is assumed that between consecutive imaging positions camera 22 may rotate through a small angle α around its optic axis by, tilt through a small angle β about a horizontal axis perpendicular to the optic axis and pan through a small angle γ about a vertical axis perpendicular to the optic axis. Under these assumptions Δx′, Δy′ are expressed by
Δx′=S(x′,y′)Δt+γ+αy′ and 8)
Δy′=β+αx′, 9)
where the small angle approximations cos α=1 and sin α=α are used. Using equations 8) and 9) for (Δx′, Δy′ respectively in equation 7) and minimizing the expression provides values for Δt, α, β and γ. In some embodiments of the invention, if camera 22 is assumed to undergo rotations that cannot be accurately approximated by expressions 8) and 9) more accurate expressions for Δx′, Δy′ are used in equation 7) to determine Δt, α, β and γ.

A suitable processor or computer optionally carries out the preceding methods for determining straight-line EP trajectories and corresponding warped t-coordinates automatically. However, the human eye-brain apparatus is very sensitive to and adept at recognizing lines in general and straight lines in particular as is readily attested to, for example, by human sensitivity to moire patterns and in some embodiments of the invention, morphing EP trajectories into straight-line trajectories is done manually. To facilitate manual morphing of EP trajectories in an ST volume, a computer optionally color-codes pixels in camera images that define the ST volume so that pixels belonging to a same EP trajectory have a same color and pixels associated with different EP trajectories have different colors. The computer displays EP planes optionally comprising the color-coded pixels on a suitable video screen and a human operator activates an input device such as a keyboard or joystick to position the camera images and straighten out the EP trajectories.

Whereas the above examples describe generating a mosaic at a 0° azimuth angle, an embodiment of the invention may be practiced to generate mosaics from sequences of images of a scene at azimuth angles other than 0° and mosaics comprising data at different azimuth angles.

For example, assume that a mosaic corresponding to a mosaic plane at azimuth angle ξ is to be generated from a sequence of camera images, in accordance with an embodiment of the present invention. If a mosaic at 0° is generated in accordance with an embodiment of the invention from mosaic strips having width MS(0°), then the mosaic at angle ξ is generated in accordance with an embodiment of the invention from mosaic strips optionally having width MS(ξ)=MS(0°)|cos ξ|. A mosaic comprising data at different azimuth angles generally corresponds either to a mosaic plane that is not parallel to the y′t-plane of an ST volume comprising a sequence of camera images or to a surface that passes through the ST volume that is not a plane. In some embodiments of the invention, if the mosaic is generated from mosaic strips at different azimuth angles, mosaic strips at different azimuth angles may have different widths and strips at a given azimuth angle ξ optionally have a width equal to MS(ξ)=MS(0°)|cos ξ|.

Mosaics generated at azimuth angles other than at 0° azimuth are described in an article by A. Zomet, et. al., “Mosaicing New Views: The Crossed-Slits Projection”, IEEE Trans. on PAMI, June 2003, pp. 741-754; by S. Peleg, et. al, in an article “OmniStereo: Panoramic Stereo Imaging”, IEEE Trans. on PAMI, March 2001, pp. 279-290; and in U.S. Pat. No. 6,665,003, the disclosures of which are incorporated herein by reference.

Mosaics in accordance with an embodiment of the invention may also be generated from mosaic strips that are not rectangular but are curved. In accordance with an embodiment of the present invention, a mosaic is generated from curved mosaic strips using methods similar to those described in U.S. Pat. No. 6,532,036, the disclosure of which is incorporated herein by reference. Widths of the curved strips are determined responsive to warped t-coordinates determined for camera images comprising the strips, in accordance with an embodiment of the invention.

In the exemplary embodiments of the present invention described above camera 22 moves along a straight line substantially parallel to scene 22 with its optic axis 34 substantially perpendicular to the scene. However, methods for generating mosaics in accordance with the present invention are applicable when the straight-line path of the camera is not parallel to the scene and/or the camera optic axis is not perpendicular to the scene. For such case images acquired by the camera can be rectified using known techniques so that they appear as if acquired by a camera moving along a straight line parallel to the scene and having its optic axis perpendicular to the scene.

In the above discussion, it is assumed that camera 22 translates substantially along a straight line. However, the present invention is not limited to straight-line motion and may be practiced, for example, in any situation for which pixel motion is approximately a linear function of camera motion. In particular, the present invention can be practiced for camera motion along an arc of a circle, for camera motion in a plane and camera motion on the surface of a sphere.

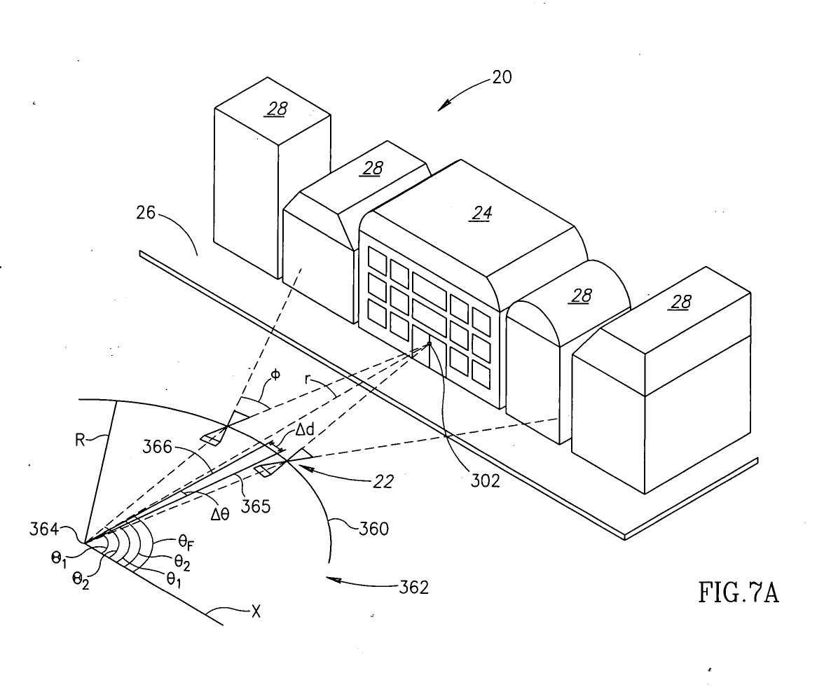

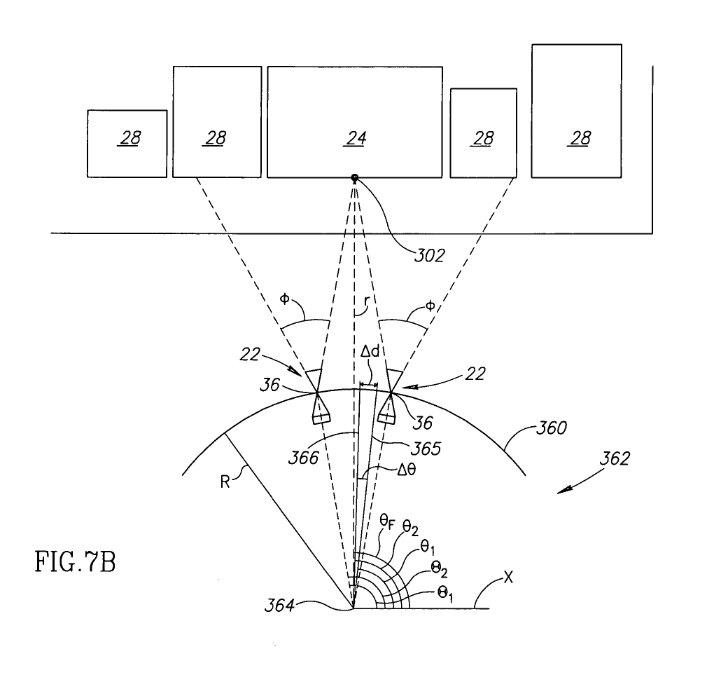

FIGS. 7A and 7B schematically show perspective and plan views of camera 22 moving along an arc 360 of a circle 362 and acquiring images, for example, of scene 20 at imaging positions defined by an azimuth angle θ measured relative to the x-axis. Circle 362 has center 364 and radius R and its plane is, by way of example, horizontal and parallel to street 26.

Image x′-coordinates of pixels that image features in scene 20 in camera images acquired by camera 22 are substantially linear functions of the imaging position angles θ that define the imaging positions at which the images are acquired. As a result, in an ST volume defined by the camera images of scene 20 acquired by camera 22, EP trajectories of features are substantially straight lines if the times at which the camera images are acquired are substantially proportional to their respective imaging position angles. Conversely, if the camera images are arrayed at t-coordinates, i.e. “warped” t-coordinates, in an ST volume so that EP trajectories are straight lines, in accordance with an embodiment of the invention, the t-coordinates are proportional to the imaging position angles θ at which the camera images are acquired. A mosaic generated responsive to the warped t-coordinates, in accordance with an embodiment of the invention, will in general have less distortion than a mosaic generated by a conventional 2D prior art method, such as by a fiducial algorithm.

Dependence of x′-coordinate of a feature 302 in scene 20 on imaging position angle θ illustrates the linear dependence of x′-coordinate on θ. Let feature 302 be located at an azimuth angle θ_{F} at a distance r from center 364 and let the field of view of camera 22 be defmed by an angle φ. Feature 302 first enters the field of view of camera 22 at an imaging position angle θ=Θ₁ and leaves the field of view at a second imaging position angle θ=Θ₂.

Assume that an angle Δθ separates the imaging position angles θ₁ and θ₂ of first and second imaging positions indicated by lines 365 and 366 and that a cord of length Δd connects the two imaging positions. Between imaging positions 365 and 366 camera 22 undergoes a panning rotation through an angle Δθ about an axis perpendicular to the plane of circle 362 through the camera's optical center 36 and a translation substantially parallel to scene 20 equal to Δx=Δd cos(θ_{F}−θ₁). As a result of camera displacements Δx and Δθ, the pixel that images feature 302 is displaced from its position in the camera image acquired at imaging position 365 to its position in the camera image acquired at imaging position 366 by a displacement Δx′ given by:
Δx′=[f/(r−R)]Δx+fΔθ=[f/(r−R)]Δd cos(θ_{F}−θ₁)+fΔθ, 10)
where f is the focal length of camera 22.

Noting that (Θ₂−Θ₁)≅φR/(r−R) and that generally R/(r−R)<<1, an approximation can be made that in equation 10) cos(θ_{F}−θ₁)≅1 and using a small angle approximation Δd≅RΔθ, equation 10) becomes
Δx′=[f/(r−R)]RΔθ+fΔθ=f[r/(r−R)]Δθ. 11)
Assuming that when feature 302 first enters the field of view of camera 22 it has an image x′-coordinate equal to xₒ the x′ coordinate in camera images acquired by camera 22 can be written
x′=x′ₒ+f[r/(r−R)]θ. 12)

It is noted that as R→∞, equations 11) and 12) approach equations that describe pixel motion as a function of motion of camera 22 along a straight line parallel to scene 20 at a distance z from the scene. This may be shown by writing Δθ=Δd/R in equation 11) and noting that in the limit as R→∞ while holding (r−R)=z, equation 11) approaches Δx′=[f/z]Δd. Identifying Δd with Δx gives the relationship shown in equation 4)Δx′=ΔxM=Δx [f/z].

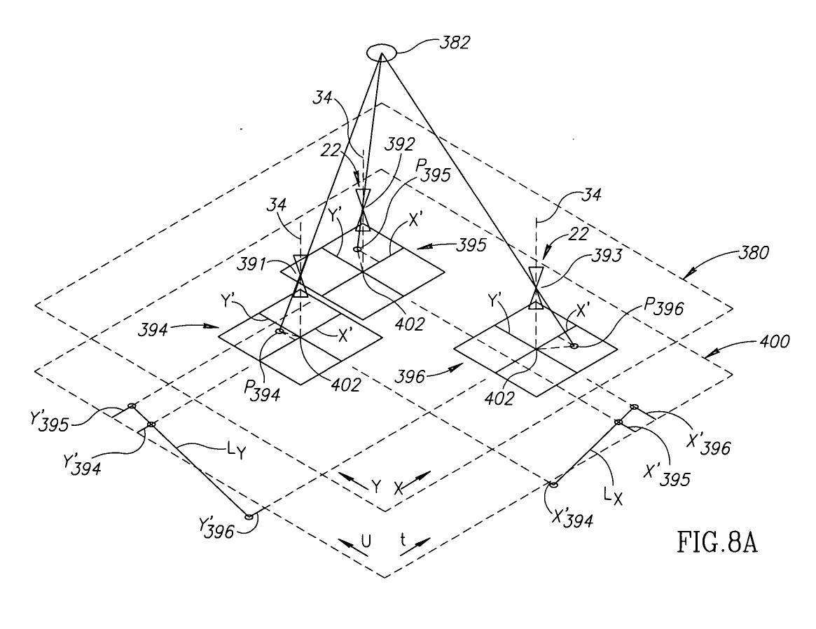

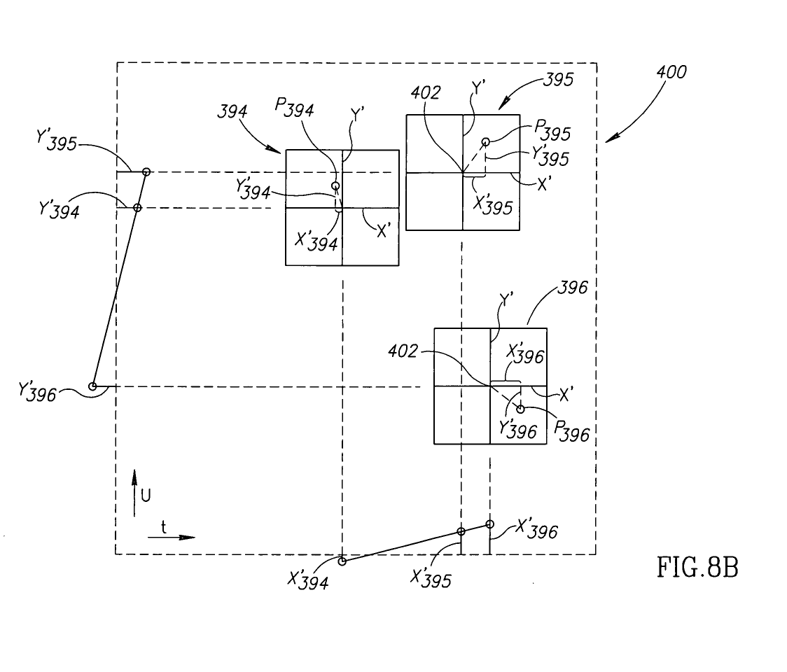

FIG. 8A schematically shows a perspective view of camera 22 moving along a plane 380 and acquiring images, of a feature 382 in a scene (not shown) at camera imaging positions in the plane defined by x and world y-coordinates. Optic axis 34 of camera 22 is, by way of example, perpendicular to plane 380 and the camera is schematically shown at three imaging positions 391, 392 and 393 in the plane. Camera images 394, 395 and 396 corresponding to camera imaging positions 391, 392 and 393 are shown in an “image plane” 400 parallel to plane 380. Each camera image 394, 395 and 396 is projected onto plane 400 from its corresponding imaging position along a direction of optic axis 34 of camera 22. At the imaging position 391, 392 or 393 corresponding to a given camera image 394, 395 or 396 optic axis 34 intersects the given image at an image center point 402 corresponding to the center of the field of view at the camera. A pixel in a camera image acquired by camera 22, such as camera images 394, 395 and 396, is located in the camera image by coordinates along x′ and y′-axes that intersect at the camera images center point 402. The x′ and y′-axes are parallel respectively to the x and y-axes.

Center point 402 of each camera image is located in plane 400 by coordinates along t and u-axes that are respectively parallel to the x and y-axes. By construction, the t and u-coordinates of a center point 402 of a camera image 394, 395 or 396 are proportional to the x and y-coordinates respectively of the imaging position at which the camera image is acquired. FIG. 8B schematically shows a plan view of plane 400.

Feature 382 is imaged at pixels P₃₉₄, P₃₉₅ and P₃₉₆ in images 394, 395 or 396 respectively. The x′-coordinate of each pixel P₃₉₄, P₃₉₅ and P₃₉₆ is proportional to the x-coordinate of the corresponding imaging position 391, 392 and 393 at which camera 22 acquires camera images 394, 395 or 396 respectively. Similarly, the y′-coordinate of each pixel P₃₉₄, P₃₉₅ and P₃₉₆ is proportional to the y-coordinate of camera 22 at the corresponding imaging positions 391, 392 and 393 (with a same constant of proportionality as relates the x-coordinate to the x′-coordinate).

Therefore, if the x′-coordinates of pixels P₃₉₄, P₃₉₅ and P₃₉₆ are plotted as a function of the t-coordinates of the center points of their respective images 394, 395 or 396, the x′-coordinates lie along a straight line. Similarly, if the y′-coordinates of pixels P₃₉₄, P₃₉₅ and P₃₉₆ are plotted as a function of the u-coordinates of the center points of images 394, 395 or 396 respectively, the y′-coordinates lie along a straight line. Since the x′ and y′-coordinates of a pixel are proportional to the x and y-coordinates of imaging positions of camera 22 with a same proportionality constant, the slopes of the lines defined by the x′ and y′-coordinates are the same. FIGS. 8A and 8B show the x′-coordinates labeled x′₃₉₄, x′₃₉₅ and x′₃₉₆ and y′-coordinates labeled y′₃₉₄, y′₃₉₅ and y′₃₉₆ of pixels P₃₉₄, P₃₉₅ and P₃₉₆ respectively graphed along the t and u-axes respectively and the straight lines Lx and Ly along which they lie.

From the above discussion it is seen that if the x and y coordinates of the imaging positions at which camera 22 images feature 382 and other features in the scene are unknown, they can be determined, in accordance with an embodiment of the invention, to within a constant of proportionality by aligning the images in the tu-plane so that the x′ and y′-coordinates of the features are linear functions of the t and u-coordinates respectively. A mosaic of the scene in accordance with an embodiment of the invention, is generated responsive to the t and u-coordinates. In some embodiments of the invention, the mosaic is generated from a mosaic “patch” defined for each camera image and having dimensions responsive to the t and u-coordinates associated with the camera image and adjacent camera images. Optionally, Voronoy diagrams, as noted in the U.S. Provisional Application 60/552,393 cited above are used to define the patches. A mosaic, in accordance with an embodiment of the invention, generated responsive to the t and u-coordinates for the images determined by the linearizing process, and a suitable warping constant will in general exhibit less distortion than a mosaic generated by a prior art method.

Similarly to the way in which the present invention is generalized to apply to motion of a camera in a plane for which two, optionally rectilinear coordinates, are used to define camera position, the invention is generalized to apply for camera motion on the surface of a sphere. For camera motion on a sphere, two angles are optionally used to define the camera position. The x′ and y′-coordinates on the camera focal plane of an image of a feature in a scene imaged by the camera may be expressed as linear functions of the two angles, suitable warped in accordance with the present invention.

It should be noted that practice of embodiments of the present invention is not limited to the exemplary scenarios illustrated above. Embodiments of the invention are applicable to imaging scenarios and configurations different from those described above. For example, in exemplary examples described above, the camera optic axis is perpendicular to the locus of camera motion when it acquires images of a scene. In cases for which the optic axis is not perpendicular to the locus of motion, images acquired by the camera may be rectified using any of many different rectification methods known in the art to transform the images to images consistent with their being acquired with camera optic axis perpendicular to the motion locus. Methods of image rectification are described in an article by Z. Zhu and A. R. Hanson, entitled “Parallel-Perspective Stereo Mosaics”, ICCV01, pp. II: 345-352, 2001, and in R. Hartly, “Theory and Practice of Projective Rectification”, IJCV, 35(2):1-16, November 1999, the disclosures of which are incorporated herein by reference.

Furthermore, the invention may be practiced with variations of the mosaicing methods described and with mosaicing methods different from those described. For example, in some embodiments of the invention, mosaic strips are not relatively narrow strips but may be relatively wide strips and may even include entire camera images. Wide strips generally overlap and image same regions of a scene. For such cases image data for overlapping pixels may be averaged, optionally using an appropriate weighting function, in providing a mosaic in accordance with an embodiment of the invention. Also, as noted above, embodiments of the invention may be practice using mosaicing methods that do not involve strips.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method of generating a mosaic from a plurality of camera images of a scene acquired by a camera moving relative to the scene, the method comprising:
associating with each camera image a value of at least one variable so that the variable is a substantially a linear function of a spatial coordinate that defines the locations of the camera at which it acquires the images by requiring that a coordinate of pixels in the camera images that image a same feature in the scene is substantially a linear function of the variable; and
generating the mosaic responsive to the at least one variable.

2. A method according to claim 1 wherein the at least one variable is a single variable.

3. A method according to claim 2 wherein the camera moves along a straight line and the spatial coordinate determines displacement of the camera along the line.

4. A method according to claim 2 wherein the camera moves along an arc of a circle and the spatial coordinate is an angle that determines location of the camera among the arc.

5. A method according to claim 2 wherein the camera moves in a plane and the spatial coordinate is a coordinate that determines the location of the camera along an axis in the plane.

6. A method according to claim 2 wherein the camera moves on the surface of a sphere and the spatial coordinate is an angle that determines the location of the camera on the surface relative to a direction of an axis through the center of the sphere.

7. A method according to claim 1 wherein the variable is a time coordinate along a time axis of a space-time (ST) volume defined by the images.

8. A method according to claim 7 wherein associating values of the time coordinate comprises associating the values by requiring that at least one trajectory in an epipolar (EP) plane of the ST volume defined by pixels that image a same feature in the scene is substantially a straight line.

9. A method according to claim 8 wherein associating the values of the time coordinate comprises determining the values so that they optimize at least one global measure responsive to coordinates of the pixels in the EP plane that has a value indicative of an extent to which EP trajectories in the EP planes are straight lines.

10. A method according to claim 9 wherein the global measure comprises the entropy of at least one transform.

11. A method according to claim 10 wherein the at least one transform comprises a Fourier transform.

12. A method according to claim 10 wherein the at least one transform comprises a Radon transform.

13. A method according to claim 8 wherein associating the values of the time coordinate comprises determining the values using an iterative procedure.

14. A method according to claim 13 wherein using an iterative procedure comprises associating a time coordinate value for each camera image in turn responsive to time coordinate values already determined for other camera images.

15. A method according to claim 8 wherein associating the values of the time coordinate comprises visually spacing the camera images along the time axis so that the at least one trajectory is substantially a straight line.

16. A method according to claim 7 wherein generating the mosaic comprises generating an image of a mosaic plane of the ST volume, which image of the mosaic plane comprises pixels in the camera images that lie along mosaic lines, which are lines of intersection of the mosaic plane with the camera images.

17. A method according to claim 16 and comprising generating values for pixels in the mosaic plane at locations between mosaic lines responsive to the associated time coordinates.

18. A method according to claim 16 wherein generating the mosaic comprises defining a mosaic strip for each camera image in the ST volume that comprises the mosaic line in the camera image and juxtaposing the mosaic strips contiguous with each other to generate the mosaic.

19. A method according to claim 18 and comprising determining a width for the mosaic strip of a given camera image in the ST proportional to differences between the time coordinate assigned the given camera image and the time coordinates assigned adjacent camera images in the ST volume.

20. A method according to claim 19 and comprising determining the width of the strip responsive to a distance of a feature in the scene that is imaged in the strip.

21. A method according to claim 1 wherein, two spatial coordinates define the camera position and the at least one variable comprises two variables.

22. A method according to claim 21, wherein each variable is a linear function of a different spatial coordinate.

23. A method according to claim 21 wherein the camera moves in a plane and the different coordinates comprise two coordinates that define the location of the camera in the plane.

24. A method according to claim 21 wherein the camera moves on a region of a spherical surface and the different spatial coordinates comprise two angles that define the location of the camera on the region.

25. A method according to claim 21 wherein associating with each camera image values of the two variables comprises associating the values so that each of two coordinates of pixels in the camera images that image a same feature in the scene is a linear function of at least one of the variables.

26. A method according to claim 25 wherein each pixel coordinate is a linear function of a different one of the variables.

27. A method according to claim 1 wherein the optic axis of the camera is substantially perpendicular to the locus of its motion or the camera images are rectified to correspond to camera images acquired with the camera optic axis perpendicular to its locus of motion.

28. A method according to claim 27 and the mosaic corresponds to an image of the scene oriented at a 0° azimuth angle relative to the optic axis of the camera.

29. A method according to claim 27 wherein the mosaic corresponds to an image of the scene oriented at an azimuth angle other than 0° relative to the optic axis of the camera.

30. A method according to claim 27 wherein the mosaic comprises pixels that image features in the scene at different azimuth angles relative to the optic axis of the camera.

31. A method according to claim 21 wherein the optic axis of the camera is substantially perpendicular to the locus of its motion or the camera images are rectified to correspond to camera images acquired with the camera optic axis perpendicular to its locus of motion.

32. A method according to claim 31 and the mosaic corresponds to an image of the scene oriented at a 0° azimuth angle relative to the optic axis of the camera.

33. A method according to claim 31 wherein the mosaic corresponds to an image of the scene oriented at an azimuth angle other than 0° relative to the optic axis of the camera.

34. A method according to claim 31 wherein the mosaic comprises pixels that image features in the scene at different azimuth angles relative to the optic axis of the camera.
